(19) United States
(12) Patent Application Publication
(10) Pub. No.: US 2005/0151354 A1
(43) Pub. Date: Jul. 14, 2005

(54) Steering device and airbag system

(75) Inventor: Shinichi Sugimoto, Hikone-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: TAKATA CORPORATION, Tokyo (JP)

(21) Appl. No.: 11/032,040

(22) Filed: Jan. 11, 2005

(30) Foreign Application Priority Data
Nov. 8, 2004 (JP) 2004-323883
Jan. 14, 2004 (JP) 2004-007012
Jan. 14, 2004 (JP) 2004-006599

(51) Int. Cl. B60R 21/16

(52) U.S. Cl. 280/731

(57) ABSTRACT

A steering device includes a cover device adapted to be disposed on a steering wheel, a guiding device adapted to be disposed in the steering wheel for guiding the cover device to move parallel to an axial direction of the steering wheel, and a horn switch attached to the cover device for switching a horn when the cover device moves in the axial direction. The guiding device includes arms having first ends and second ends respectively. The first ends are joined together and supported such that the arms freely rotate together around the first ends in the axial direction, and the second ends extend in directions away from each other and being connected to the cover device. An airbag device can be attached to the steering device as an airbag system.

### BACKGROUND OF THE INVENTION AND RELATED ART STATEMENT

The present invention relates to a steering device and an airbag system having a horn switch and mounted on a steering device of a vehicle such as an automobile. In the airbag system, when a module cover is pressed and an airbag system body or a module cover moves toward a steering wheel, a horn switch is turned on.

In a driver airbag system provided in a steering wheel of an automobile, when a module cover of the airbag system is pressed, an airbag system body or the module cover moves toward the steering wheel, so that contacts of a horn switch are closed, thereby blowing a horn.

U.S. patent application Publication No. 2003/0025308A1 has disclosed such an airbag system, in which when the airbag system is pressed from above, the airbag system is withdrawn through parallel movement and a horn switch is turned on. The airbag system is supported on an end of a parallel link extending in a direction perpendicular to a steering axis direction. The other end of the parallel link is fixed to a steering wheel body. The horn switch is disposed on a rear surface of the airbag system, and a spring is provided in the horn switch for urging the airbag system upwardly (an axis direction of a steering column toward a driver).

In U.S. patent application Publication No. 2003/0025308A1, when the airbag system is pressed from above, the airbag system is guided with the parallel link and moves in parallel in the steering axis direction without inclination. Accordingly, when the airbag system moves in parallel, a constant reactive force is applied to a finger tip of a driver from the airbag system, even if any position of the upper surface of the airbag system is pressed.

In U.S. patent application Publication No. US2003/0025308A1, when the airbag system body is pressed and withdrawn, the parallel link is slightly shifted in a horizontal direction, so that it is necessary to provide a large allowance (gap) between a side surface of the airbag system body and the steering wheel. A base end of the parallel link (bridge 20′ in the publication) is disposed at a lateral circumference side of a wheel body, thereby increasing a size of the airbag system including the parallel link in a radial direction of the steering.

On the other hand, Japanese Patent Publication (Kokai) No. 11-34882 has disclosed a conventional steering wheel with a horn device. The steering wheel includes a horn switch device in which a bracket having a moving contact are urged toward an occupant with several coil springs and moves up and down through a bush relative to a support plate having a stationery contact. With this construction, when the occupant pressed a pad cover, the bracket moves toward the support plate along the bush against an urging force of the coil springs, so that the moving contact contacts the stationery contact to blow a horn.

In the steering wheel with the horn device disclosed in Japanese Patent Publication (Kokai) No. 11-34882, it is difficult to smoothly operate the horn device.

In view of the problems described above, an object of the present invention is to provide a steering device mounted on a vehicle in which a horn device operates smoothly.

Another object of the present invention is to provide an airbag system in which an airbag system body is straightly withdrawn in a steering axis direction when the airbag system is pressed to move parallel to a steering axis direction.

A further object of the present invention is to provide an airbag system having a size smaller than that of a conventional example in a radial direction of a steering.

Further objects and advantages of the invention will be apparent from the following description of the invention.

### Summary of the Invention

In order to attain the objects described above, according to a first aspect of the present invention, an airbag system comprises an airbag system body provided in a steering wheel; a guiding device for guiding the airbag system body or a module cover thereof to move in parallel in an axis direction of the steering wheel; and a horn switch with contacts for opening and closing when the airbag system body or the module cover moves. The guiding device comprises arms with first ends connected with each other and second ends extending in directions away from each other. The first ends are supported relative to the steering wheel so that the arms freely rotate in the steering axis direction. The first ends of the arms are joined with each other such that when one of the arms rotates in the steering axis direction, the other of the arms rotate in the same direction together with the one arm. The second ends of the arms are connected to the airbag system body or the module cover.

According to a second aspect, in the airbag system according to the first aspect, the second ends of the arms are connected to a bottom portion of the airbag system body or the module cover.

According to a third aspect, in the airbag system according to the first or second aspect, the first ends of the arms engage with each other.

According to a fourth aspect, in the airbag system according to the third aspect, each of the second ends is provided with a pinion, and the pinions engage with each other.

According to a fifth aspect, in the airbag system according to the first or second aspect, each of the first ends is provided with a protruding portion protruding toward an adjacent arm. The first end of the adjacent arm is provided with a locking portion, and the protruding portion and the locking portion are locked with each other.

According to a sixth aspect, in the airbag system according to the fifth aspect, the locking portion is a concave portion.

According to a seventh aspect, in the airbag system according to any one of the first to sixth aspects, a spring is provided for urging the airbag system body or the module cover to open the contacts of the horn switch.

According to an eighth aspect, in the airbag system according to any one of the first to sixth aspects, a spring is attached to the arms as an urging device for urging the horn switch to open the contacts thereof.

According to a ninth aspect, in the airbag system according to the first or second aspect, the first ends of the arms are connected with each other through springs, and the springs urge the arms in a direction that the contacts of the horn switch are opened.

According to a tenth aspect, in the airbag system according to the ninth aspect, each of the springs has a wound portion and stretched portions extending in a direction away from each other. The wound portion is retained in one of the arms, and one of the stretched portions is fixed to the one of the arms and the other of the stretched portions is fixed to the other of the arms.

According to an eleventh aspect, in the airbag system according to the tenth aspect, wherein the one of the arms is provided with a spring retaining protrusion, and the wound portion of the spring is fitted to the spring retaining protrusion.

In the airbag system according to the present invention, a pair of the arms of the guiding device rotates such that the first ends approach and recede from the steering wheel with the second ends as a rotation center. The second ends of the arms extend in the direction away from each other and are connected to the airbag system body. Accordingly, when the airbag system body or the module cover is pressed, the airbag system body moves straight in parallel without shifting in a direction intersecting the steering axis direction with the rotation of the arms.

In the airbag system according to the present invention, the airbag system body moves in parallel toward the steering wheel. Accordingly, a constant reactive force from the module cover is applied to a finger tip of an operator (driver), even if any position on an upper surface of the module cover (the airbag system body) is pressed. As a result, it is possible to reduce a space between a side surface of the airbag system body and the steering wheel.

In the airbag system according to the second aspect, the second end of each arm is connected to the bottom surface of the airbag system body, and each arm does not protrude laterally from the airbag system body. Accordingly, it is possible to reduce a size of the airbag system in a diameter direction of the steering.

In the airbag system according to the third aspect, since the second ends of the arms engage each other, the arms can be securely connected with each other.

In the airbag system according to the fourth aspect, since the pinions of the arms engage each other, the arms can be smoothly connected.

In the airbag systems according to the fifth and sixth aspects, since the structure is relatively simplified, it is possible to reduce cost of the system.

In the airbag systems according to the seventh aspect, the spring is provided as the urging device for urging the airbag system body or the module cover to open the horn switch. In the airbag system according to the eighth aspect, the spring may be provided in the arms as the urging device.

In the airbag systems according to the ninth aspect, the first ends of the arms are connected with each other through the spring as the urging device.

In the airbag system according to the tenth aspect, since the spring has the wound portion, the wound portion is wrenched to obtain a sufficient restoring force when the arms rotate.

In the airbag system according to the eleventh aspect, since the wound portion is retained in the spring retaining protrusion of the arm, the wound portion is securely wrenched when the arms rotate.

In the airbag system according to the present invention, a pair of the arms of the guiding device rotates such that the first ends approach and recede from the steering wheel with the second ends as a rotation center. The second ends of the arms extend in the direction away from each other and are connected to the airbag system body. Accordingly, when the airbag system body or the module cover is pressed, the airbag system body moves straightly in parallel without shifting in a direction intersecting the steering axis direction with the rotation of the arms.

In the airbag system according to the present invention, the airbag system body moves in parallel toward the steering wheel. Accordingly, a constant reactive force from the module cover is applied to a finger tip of an operator (driver), even if any position on an upper surface of the module cover (the airbag system body) is pressed. As a result, it is possible to reduce a space between a side surface of the airbag system body and the steering wheel.

In the airbag system according to the second aspect, the second end of each arm is connected to the bottom surface of the airbag system body, and each arm does not protrude laterally from the airbag system body. Accordingly, it is possible to reduce a size of the airbag system in a diameter direction of the steering.

In the airbag system according to the third aspect, since the second ends of the arms engage each other, the arms can be securely connected with each other.

In the airbag system according to the fourth aspect, since the pinions of the arms engage each other, the arms can be smoothly connected.

In the airbag systems according to the fifth and sixth aspects, since the structure is relatively simplified, it is possible to reduce cost of the system.

In the airbag systems according to the seventh aspect, the spring is provided as the urging device for urging the airbag system body or the module cover to open the horn switch. In the airbag system according to the eighth aspect, the spring may be provided in the arms as the urging device.

In the airbag systems according to the ninth aspect, the first ends of the arms are connected with each other through the spring as the urging device.

In the airbag system according to the tenth aspect, since the spring has the wound portion, the wound portion is wrenched to obtain a sufficient restoring force when the arms rotate.

In the airbag system according to the eleventh aspect, since the wound portion is retained in the spring retaining protrusion of the arm, the wound portion is securely wrenched when the arms rotate.

According to a twelfth aspect of the present invention, a steering device includes the following structure before a horn device is attached to a steering wheel or after a horn device is attached to a steering wheel. The steering device has a pressing portion, i.e., a portion to be pressed by a driver, movable between an initial position and a working position. The initial position is a set position (standby position) of the pressing portion before the driver presses the pressing portion, and the working position is a set position of the pressing portion when a horn works. An elastic urging device such as a coil spring and a plate spring urges the pressing portion to the initial position. When the driver presses the pressing portion to move to the working position, the horn works. That is, the horn blows when the pressing portion moves to the working position. For example, two contacts of a horn switch device contact with each other electrically, thereby blowing the horn. When the driver releases the pressing portion to return to the initial position, the horn stops. That is, the horn stops when the pressing portion moves the initial position from the working position.

In the present invention, when the pressing portion is pressed, a pressing component is obtained in a direction toward the working position from the initial position. The pressing portion is pressed in a pressing direction (application direction of a pressing force), and the pressing portion may or may not move in the pressing direction. When the pressing portion does not move in the pressing direction, the pressing portion may move in a direction slightly intersecting the pressing direction. In this case, it is still possible to obtain the pressing component in the direction toward the working position from the initial position when the pressing portion is pressed.

In the present invention, the steering device comprises a movement-direction defining device for defining a movement direction of the pressing portion. The movement-direction defining device allows the pressing portion to move in a predetermined direction from the initial position to the working position, and regulates the pressing portion not to move in a direction other than the predetermined direction. With the movement-direction defining device, it is possible to move the pressing portion in the predetermined direction. The pressing portion may move in a direction inclined relative to the predetermined direction. In this case, the movement-direction defining device functions as a stabilizer for controlling the movement direction of the pressing portion.

The movement-direction defining device regulates (prevents) the pressing portion not to move in a direction other than the predetermined direction. In the present invention, the pressing portion is completely restricted not to move in a direction other than the predetermined direction, or the pressing portion may slightly move in a direction other than the predetermined direction for a reason such as assembling.

In the steering device of the twelfth aspect, the movement direction of the pressing portion is defined and accurately controlled by the movement-direction defining device. Accordingly, it is possible to prevent the pressing portion from moving in an inclined direction relative to the predetermined direction when the pressing portion moves from the initial position to the working position in the predetermined direction. As a result, when a driver presses any portion of the pressing portion, the pressing force is uniformly applied to the pressing portion.

In the steering device of the twelfth aspect, the pressing portion has an effective are (a surface area of the pressing portion) where a driver can press. It is generally arranged such that the effective area has a large size as possible for a smooth operation. Accordingly, since the effective area has a large size, a driver may press an edge or a center of the pressing portion. In a conventional steering device without the movement-direction defining device of the present invention, when the driver presses the pressing portion, a pressing force for blowing the horn varies depending on a position of the pressing portion. That is, when a center of the pressing portion is pressed, it is necessary to press the pressing portion with a force against an urging force of all of coil springs. When an edge of the pressing portion is pressed, it is necessary to press the pressing force with a force against an urging force of just a part of the coil springs. As a result, in the conventional steering device, the pressing force for blowing the horn varies depending on a position of the pressing portion.

In the present invention, the steering device is provided with the movement-direction defining device. Accordingly, the pressing force for blowing the horn is constant regardless of a position of the pressing portion, thereby obtaining a smooth movement of the horn device of the steering device.

According to a thirteenth aspect of the present invention, the movement-direction defining device of the twelfth aspect is formed of a plurality of long link frames connected with a rotating shaft. Typically, two long link frames are connected with the rotating shaft to form an approximately X-shaped structural body. One end of each link frame is fixed to the pressing portion, and the other end of each link frame is fixed to a base portion of a horn switch device. Accordingly, the pressing portion as a moving unit and the base portion as a stationery unit are connected to each other through the movement-direction defining device having a plurality of long link frames and the rotating shaft.

With this structure, when the link frames rotate about the rotating shaft in a direction that the link frames approach each other, the pressing portion and the base portion approach each other. That is, a gap between the pressing portion and the base portion becomes smaller than that before the link frames rotate, thereby moving the pressing portion to the working position. On the contrary, when the link frames rotate about the rotating shaft in a direction that the link frames separate from each other, the pressing portion and the base portion separate from each other. That is, the gap between the pressing portion and the base portion becomes larger, thereby moving the pressing portion to the initial position.

In the steering device of the thirteenth aspect, the movement-direction defining device for defining the movement direction of the pressing portion is formed of a simple structure, i.e., a plurality of the long link frames and the rotating shaft.

According to a fourteenth aspect of the present invention, the movement-direction defining device of the thirteenth aspect has a structure in which one end of each link frame is fixed to the pressing portion through a clip in a one-touch way and the other end of each link frame is fixed to the base portion through a clip in a one-touch way. The one-touch way may include actions such as pressing, fitting, and hooking, which can be easily performed by an operator through a single operation. The clip may be integrated with each link frame, or may be produced individually and fixed to each link frame detachably or fixedly. The clip may be made of a resin, and have a large-diameter portion having a diameter larger than that of an inserting hole formed in the pressing portion or the base portion. The large-diameter portion of the clip is fitted into the inserting hole, so that the clip is fixed to the pressing portion or the base portion.

In the steering device of the fourteenth aspect, it is possible to easily fit the movement-direction defining device formed of the long link frames and the rotating shaft to the pressing portion or the base portion.

According to a fifteenth aspect of the present invention, the pressing portion or the base portion of the thirteenth or fourteenth aspect has a long hole extending in a longitudinal direction. At least one end of each link frame has a locking portion movable along the long hole. The locking portion may be provided at one of two ends of each link frame or at the two ends of each link frame.

With this structure, when the link frames rotate about the rotating shaft in the approaching direction or the separating direction, the locking portion slides along the long hole. That is, when the link frames rotate in the approaching direction, the locking portion is guided in the long hole to move in a direction away from the rotating shaft, so that the pressing portion moves smoothly toward the working position. When the link frames rotate in the separating direction, the locking portion is guided in the long hole to move toward the rotating shaft, so that the pressing portion moves smoothly toward the initial position. The long hole has a portion extending in a longitudinal direction, and may have various shapes as far as desired cooperation with the locking portion is obtained. For example, the long hole may formed in a linear line shape, a curved shape, or a step shape. Typically, the long hole is formed in a linear line shape, and extends in a direction intersecting the predetermined direction between the initial position and the working position, i.e., a direction perpendicular to the predetermined direction.

In the steering device of the fifteenth aspect, it is possible to smoothly move the pressing portion toward the working position or the initial position with the locking portion and the long hole.

According to a sixteenth aspect of the present invention, the steering device of any one of the twelfth to fifteenth aspects further includes an airbag mechanism mounted on the pressing portion, and formed of an airbag, an airbag cover, and a gas supply device. The airbag is expanded in a driver protecting area in case of collision of a vehicle. The airbag cover covers a driver side of the airbag, and the gas supply device supplies gas to the airbag. With this structure, when the gas supply device supplies gas to the airbag in case of collision of a vehicle, the airbag is unfolded and expanded toward the driver protecting area while tearing the airbag cover along a tear line.

In the steering device of the sixteenth aspect, it is possible to easily mount the airbag mechanism on the pressing portion.

According to a seventeenth aspect of the present invention, the movement-direction defining device of any one of the twelfth to sixteenth aspects is formed of a pre-assembled body in which the movement-direction defining device is fitted to the pressing portion in advance. The movement-direction defining device may be assembled to the pressing portion with the clip described in the fourteenth aspect. The pre-assembled body is assembled to the steering wheel of a vehicle to form the steering device.

In the steering device of the seventeenth aspect, it is possible to easily fit (assemble) the movement-direction defining device to the steering wheel of a vehicle.

According to an eighteenth aspect of the present invention, in the steering device according to any one of the twelfth to seventeenth aspects, the urging device is disposed below the pressing portion for urging the pressing portion toward the initial position. The urging device may be formed of a coil spring, a plate spring, etc.

In the steering device of the eighteenth aspect, it is possible to arrange an element above the pressing portion more freely. For example, in the steering device having the airbag described in the sixteenth aspect, it is possible to fold or arrange the airbag over a wide range above the pressing portion, thereby increasing the number of arrangements of the airbag.

According to the present invention, when the pressing portion is pressed, the pressing portion moves smoothly between the initial position and the working direction in the predetermined direction and is regulated not to move in a direction other than the predetermined direction, thereby smoothly operating the horn device of the steering device.

### BRIEF DESCRIPTION OF THE DRAWINGS

FIG. 1 is a cross-sectional view showing an airbag system in a state that a module cover is not pressed according to an embodiment of the present invention;

FIG. 2 is a cross-sectional view showing the airbag system shown in FIG. 1 in a state where the module cover is pressed;

FIG. 3 is a view showing a guide frame of the airbag system shown in FIG. 1;

FIG. 4 is an exploded perspective view showing a pivotal connection structure of an arm of the guide frame shown in FIG. 3 to a steering base;

FIG. 5 is a perspective view showing a ball joint part of the guide frame shown in FIG. 3;

FIG. 6 is a perspective view showing an engagement structure of an arm.

FIG. 7(a) is a side view showing a restoring device of the arm, and FIG. 7(b) is a perspective view showing a torsion spring as the restoring device shown in FIG. 7(a);

FIG. 8 is a perspective view of an airbag system according to another embodiment of the present invention;

FIG. 9 is an exploded perspective view of the airbag system shown in FIG. 8;

FIG. 10 is a perspective view showing a guide frame of the airbag system shown in FIG. 8;

FIG. 11 is a side view of the airbag system shown in FIG. 8;

FIG. 12 is a side view of the airbag system shown in FIG. 8;

FIGS. 13(a) and 13(b) are cross-sectional views showing a mechanism of the guide frame of the airbag system shown in FIG. 8 in a longitudinal direction of the arm;

FIG. 14 is a sectional view showing a steering device according to another embodiment of the present invention;

FIG. 15 is a plan view showing a link mechanism of the steering device;

FIG. 16 is a sectional view showing the airbag system and the link mechanism situated at an initial position;

FIG. 17 is a sectional view showing the airbag system and the link mechanism situated at a working position where a horn switch device is turned on;

FIG. 18 is a view showing a state where the link mechanism is fixed to a moving support plate and a stationery support plate with clips; and

FIG. 19 is a view showing a state where the airbag system is fixed to a steering wheel with fixing bolts.

### DETAILED DESCRIPTION OF PREFERRED EMBODIMENTS

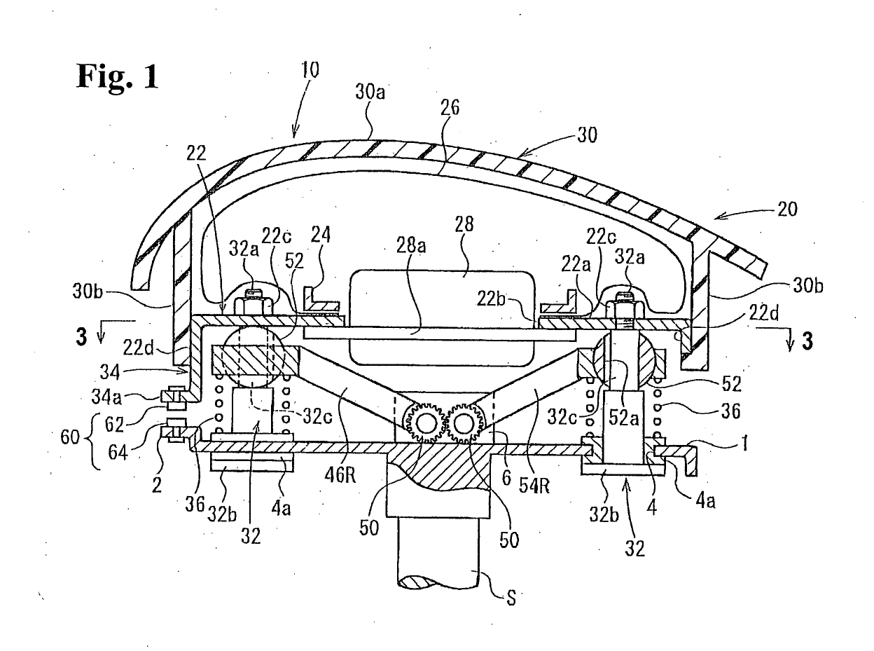

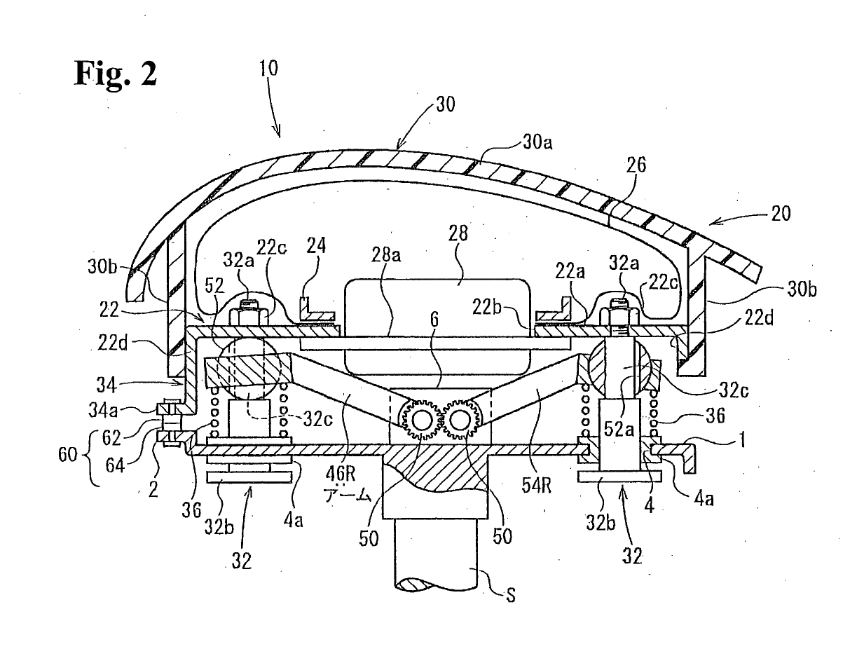

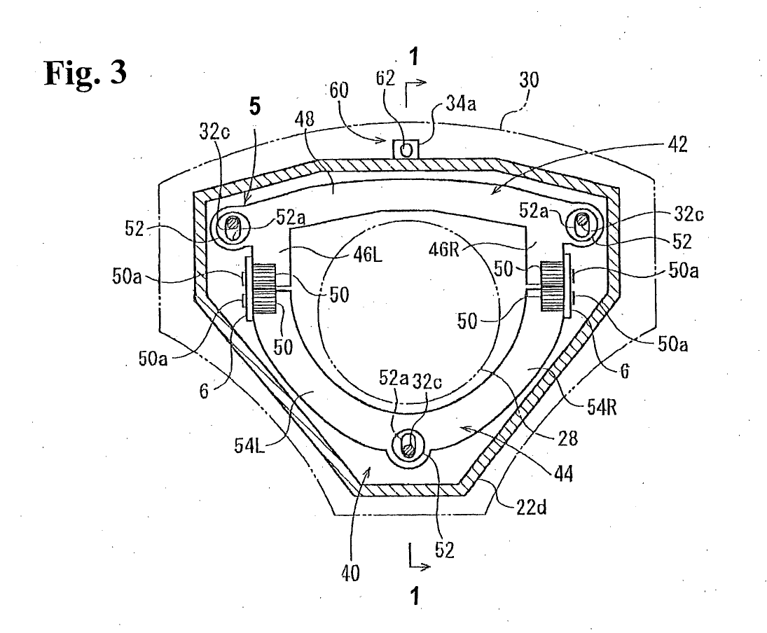

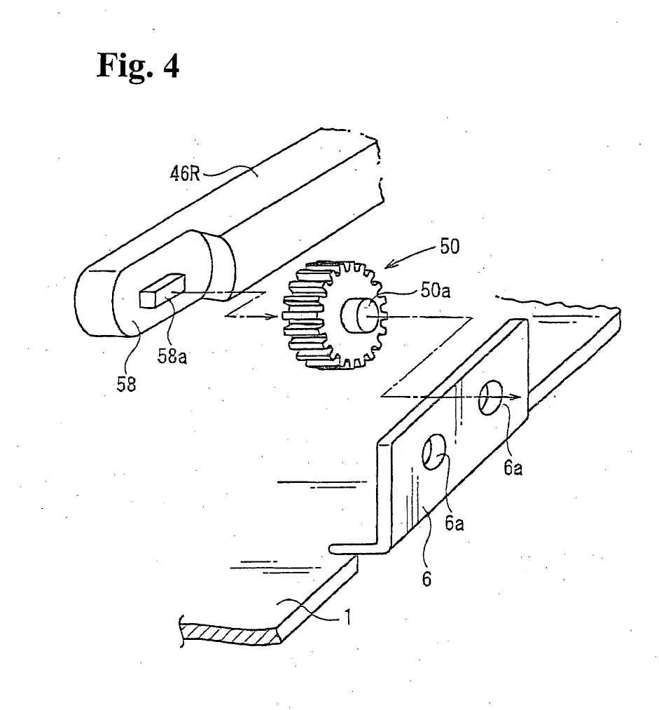

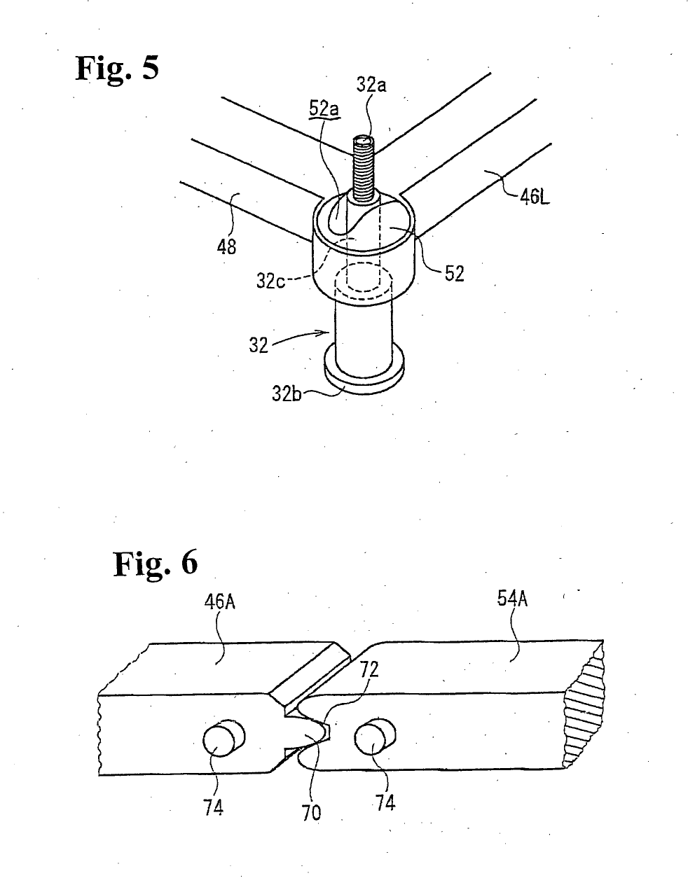

Hereinafter, embodiments of the present invention will be described with reference to the drawings. FIG. 1 is a longitudinal cross-sectional view (a cross-sectional view taken along line 1-1 in FIG. 3) illustrating an airbag system 10 according to an embodiment of the present invention in a state where a module cover is not pressed. FIG. 2 is a longitudinal cross-sectional view illustrating the airbag system 10 in a state where the module cover is pressed. FIG. 3 is a view (a cross-sectional view taken along line 3-3 in FIG. 1) illustrating a whole guide frame of the airbag system 10. FIG. 4 is an exploded perspective view illustrating a pivotal connection structure of an arm of the guide frame to a steering wheel. FIG. 5 is a perspective view illustrating a ball joint part (a portion 5 in FIG. 3) of the guide frame shown in FIG. 3. In the following description, a vertical direction indicates a vertical direction when a driver sees a steering wheel when a vehicle moves straight, i.e., a vertical direction in FIG. 3.

The airbag system 10 is a driver airbag system and is provided in a base (steering base) 1 at the center of a steering wheel. The steering base 1 is connected to a front end of a steering shaft S. The airbag system 10 comprises an airbag system body 20 disposed at a front surface (driver side) of the steering base 1; a guide frame 40 as a guiding device for guiding the airbag system body 20 such that the airbag system body is moved in parallel in an extension direction of the steering shaft S (a direction approaching and receding from the steering base 1); and a horn switch 60 to be turned on when the airbag system body 20 is guided along the guide frame 40 and moves toward the steering base 1. The guide frame 40 is disposed at a rear surface of the airbag system body 20 (at a lower side in FIGS. 1 and 2).

The airbag system body 20 comprises a retainer 22; an airbag 26 fitted to the front surface of the retainer 22 with a fitting ring 24; a gas generator 28 for inflating the airbag 26; and a module cover 30 fitted to the retainer 22 to cover the airbag 26 folded at the front surface of the retainer 22. The retainer 22 is connected to the steering base 1 through guide shafts 32. The guide shafts 32 permit the retainer 22 (the airbag system body 20) to approach and recede from the steering base 1.

The retainer 22 has a main panel portion 22a having an approximately flat plate shape, and the main panel portion 22a is provided with a gas-generator inserting port 22b. A gas-generator receiving port (reference numeral omitted) at the base end of the airbag 26 overlaps the front surface of the retainer 22 at a circumferential edge portion of the gas-generator inserting port 22b, and the fitting ring 24 overlaps therewith.

A front end (gas discharging portion) of the gas generator 28 is inserted into the airbag 26 through the gas-generator inserting port 22b and the gas-generator receiving port. A flange 28a protrudes from a side surface of the gas generator 28, and the flange 28a overlaps a rear surface of the retainer at the circumferential edge portion of the gas-generator inserting port 22b. Bolts (not shown) protrude from a rear surface of the fitting ring 24. The bolts are inserted into bolt inserting holes (not shown) provided at the circumferential edge portions of the gas-generator receiving port and the gas-generator inserting port 22b and the flange 28a. The airbag 26 and the gas generator 28 are fixed to the retainer 22 by fastening nuts (not shown) to the bolts.

Nuts 22c are fixed to the main panel portion 22a of the retainer 22 and screwed in guide shafts 32. Leg portions 22d project vertically toward a backside (opposite to the driver side) from the outer circumferential edge of the main panel portion 22a. The leg portions 22d are formed so as to surround almost all the outer circumferential edge of the retainer 22.

In the present embodiment, the leg portions 22d extends from a horizontal intermediate portion of an upper edge of the retainer 22 to the backside to form a contact retaining piece 34 for retaining one contact 62 of the horn switch 60. A front end of the contact retaining piece 34 is bent in an L-shape and forms an opposing piece 34a extending in a direction (upward in FIG. 3) intersecting an extension direction of the steering shaft S. The contact 62 is attached to the opposing piece 34a.

An opposing piece 2 extends in the same direction as the opposing piece 34a, and protrudes from an intermediate portion of the upper edge of the steering base 1 in a horizontal direction to oppose the opposing piece 34a. The other contact 64 of the horn switch 60 is attached to the opposing piece 2. When the retainer 22 (the airbag system body 20) approaches the steering base 1, the opposing pieces 34a and 2 overlap each other and the contacts 62 and 64 contact with each other, thereby turning on the horn switch 60. The contact 62 of the horn switch 60 is electrically connected to a positive side of a battery through the retainer 22, and the other contact 64 is electrically connected to a negative side through the steering base 1 and a vehicle body.

The module cover 30 has a main surface portion 30a facing a driver and a leg portion 30b rising downwardly from the rear surface of the main surface portion 30a. The leg portion 30b has a wall shape surrounding the retainer 22. The leg portion 30b overlaps a side surface of the leg portion 22b of the retainer 22, and is fixed thereto with a fixing mechanism such as a rivet. A tear line (not shown) having a groove shape is provided in a rear surface of the main surface portion 30a. When the airbag 26 is inflated, the main surface portion 30a is cleaved along the tear line with the inflating pressure of the airbag 26.

The guide shafts 32 have an approximately cylindrical shape. One end (front end) thereof is provided with a male screw portion 32a, and a flange 32b as a stopper protrudes radially from the other end (rear end) thereof. A portion ranging from an intermediate position of the guide shaft 32 in the axis direction to the base of the male screw portion 32a becomes a ball-joint retaining portion 32c to be inserted into a guide-shaft inserting hole 52a for a ball joint 52 (described later) The ball-joint retaining portion 32c has a diameter smaller than that of the portion ranging from the intermediate position of the guide shaft 32 in the axis direction to the flange 32b and larger than that of the male screw portion 32a. The ball-joint retaining portion 32c has a length equal to or slightly greater than the diameter of the ball joint 52.

The guide shafts 32 are fixed to the main panel-portion 22a of the retainer 22 with the male screw portion 32a screwed in the nut 22c, and extend to the backside from the main panel portion 22a. The rear end (the portion between the ball-joint retaining portion 32c and the flange 32b) of the guide shaft 32 is inserted into the guide-shaft inserting hole 4 provided in the steering base 1. Reference numeral 4a denotes a collar fitted to the guide-shaft inserting hole 4. As the retainer 22 (the airbag system body 20) approaches and recedes from the steering base 1, the rear end of the guide shaft 32 moves head and recedes in the guide-shaft inserting hole 4 in the axis direction.

In the present embodiment, the guide shafts 32 are provided at three positions on both horizontal sides of the upper portion of the retainer 22 and a horizontal intermediate side of the lower portion of the retainer. A coil spring 36 is externally inserted into the respective guide shafts 32 for urging the retainer 22 (the airbag system body 20) to recede from the steering base 1.

In the present embodiment, the guide frame 40 has an upper frame 42 for supporting the upper portion of the retainer 22 and a lower frame 44 for supporting the lower portion of the retainer. As shown in FIG. 3, the upper frame 42 comprises a pair of arms 46L and 46R extending approximately in an up-and-down direction; a bridge portion 48 extending in a left-and-right direction to bridge upper ends of the arms 46L and 46R; pinions (gears) 50 and 50 fixed to lower ends (front ends) of the arms 46L and 46R; and ball joints (a spherical joint capable of rotating in all directions) 52 and 52 provided at upper ends (both ends of the bridge portion 48) of the respective arms 46L and 46R.

The lower frame 44 comprises a pair of arms 54L and 54R extending approximately in the up-and-down direction and curved such that lower ends thereof approach each other to be connected; pinions 50 fixed to upper ends (front ends) of the respective arms 54L and 54R; and a ball joint 52 provided at the center of-the arms 54L and 54R.

As shown in FIG. 4, the pinion 50 is fixed to the front end of each arm 46L, 46R, 54L, and 54R (only the arm 46R is shown in FIG. 4) such that the axis direction is aligned with the left-and-right direction. A notched concave end surface 58 is formed on an outward surface (an opposite surface of the opposing surfaces between the arms 46L and 46R and between the arms 54L and 54R) of the front end of each arm 46L, 46R, 54L, and 54R. A protrusion 58a having a rectangular rod shape protrudes from the concave end surface 58, and the surface of the pinion 50 opposing the concave end surface 58 is provided with a rectangular hole (not shown) for receiving the protrusion 58a. The protrusions 58a are fitted in the rectangular holes, so that the pinions 50 are fixed to the arms 46L, 46R, 54L, and 54R so as not to rotate. The pinions 50 may be coupled to the respective arms with an adhesive as needed.

As shown in FIG. 4, a rotation axis 50a protrudes from the opposite end surface of the surface facing the concave end surface 58 of each pinion 50. As shown in FIG. 3, in the upper frame 42 and the lower frame 44, the pinions 50 at the front ends of the left arms 46L and 54L engage each other, and the pinions 50 at the front ends of the right arms 46R and 54R engage with each other.

Retaining pieces 6 are raised from the lateral edges of the steering base 1 for retaining the pinions 50 to be rotatable. Each retaining piece 6 is provided with two through holes 6a at an interval equal to a gap between the rotation axes 50a of the pinions 50, and the rotation axes 50a of the pinions 50 are inserted into the through holes 6a. As a result, the arms 46L, 46R, 54L, and 54R are fixed to the steering base 1 through the pinions 50 and the retaining pieces 6 so as to rotate about the rotation axis 50a of each front end. Since the pinions 50 engage with each other, the left arms 46L and 54L opposing each other and the right arms 46R and 54R opposing each other are connected with each other and rotate such that the ball joints 52 approach and recede from the steering base 1.

The respective ball joints 52 are provide with the guide-shaft inserting holes 52a for inserting the ball-joint retaining portions 32c of the guide shafts 32. When the ball joints 52 are inserted into the ball-joint retaining portions 32c of the guide shafts 32 through the guide-shaft inserting holes 52a, the upper ends of the arms 46L and 46R of the upper frame 42 are rotatably connected to the rear surface of the upper portion of the retainer 22, and the lower ends of the arms 54L and 54R of the lower frame 44 are rotatably connected to the rear surface of the lower portion of the retainer 22. The front ends of the coil springs 36 externally inserted into the guide shafts 32 contact the arms 46L, 46R, 54L, and 54R, and the rear ends thereof contact the collar 4a.

Each guide-shaft inserting hole 52a has a longitudinally elongated shape as shown in FIGS. 3 and 5, and the ball-joint retaining portion 32c of each guide shaft 32 can be relatively moved in the guide-shaft inserting hole 52a in the up-and-down direction (in the direction intersecting the axis direction of the guide shaft 32.

In the airbag system 10 with the aforementioned structure, when the module cover 30 is pressed toward the steering wheel, as shown in FIG. 2, the airbag system body 20 approaches the steering base 1 and the contacts 62 and 64 contact with each other, thereby blowing the horn. At this time, the arms 46L, 46R, 54L, and 54R of the upper frame 42 and the lower frame 44 supporting the retainer 22 of the airbag system body 20 rotate toward the steering base 1 about the rotation axis 50a while compressing the coil springs 36 with the movement of the retainer 22.

When a hand moves away from the module cover 30, the arms 46L, 46R, 54L, and 54R and the airbag system body 20 are restored to the state shown in FIG. 1 due to the biasing force of the coil springs 36, and the contacts 62 and 64 recede from each other, so that the horn stops. The vertical displacements (deviation of the ball joints 52 from the guide shafts 32) of the ball joints 52 due to the rotation of the arms 46L, 46R, 54L, and 54R are absorbed by the vertical relative movement of the ball-joint retaining portions 32c of the guide shafts 32 within the guide-shaft inserting holes 52a with an elongated shape of the ball joints 52.

In the airbag system 10, the left arms 46L and 54L and the right arms 46R and 54R of the upper frame 42 and the lower frame 44 rotate through the pinions 50 connected with each other, respectively. Accordingly, the retainer 22 (the airbag system body 20) with the upper portion and the lower portion supported by the arms 46L, 46R, 54L, and 54R is always parallel-moved toward the steering base 1, even when, for example, an outer edge portion other than the center of the module cover 30 is pressed. As a result, the coil springs 36 biasing the airbag system body 20 are all compressed uniformly. Therefore, even if any position of the module cover 30 is pressed, the reactive force applied to the finger tip of an operator (driver) is always constant.

In the airbag system 10, the guide frame 40 is disposed at the rear surface side of the airbag system body 20 for guiding the movement of the airbag system body 20 as the guiding device. Accordingly, the steering diameter-direction size of the center of the steering wheel can be reduced and made relatively small.

In the aforementioned embodiment, the pinions 50 and the arms 46L, 46R, 54L, and 54R are individually provided, and may be integrally provided. In the present invention, an engagement structure other than the pinion (gear) may be employed.

FIG. 6 is a perspective view illustrating another example of the engagement structure between the arms.

In FIG. 6, a protrusion 70 is provided as a protruding portion extending from the front end of one arm 46A to the other arm 54A, and the front end of the other arm 54A is provided with a concave portion 72 as a locking portion locked with the protrusion 70. The arms 46A and 54A rotate while connecting with each other by locking the protrusion 70 with the concave portion 72. In the present embodiment, a rotation axis 74 protrudes from a side surface of each arm 46A and 54A. By inserting the rotation axes 74 into the through holes of retaining pieces 6 (not shown in FIG. 6), the arms 46A and 54A are rotatably fixed to the steering base 1.

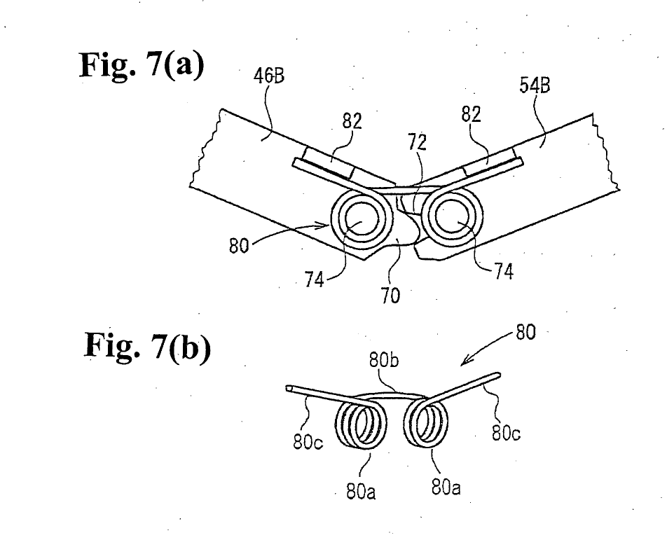

In the aforementioned embodiment shown in FIGS. 1 to 5, the airbag system body 20 and the arms 46L, 46R, 54L, and 54R are biased in a restoring direction by the coil springs 36 externally inserted to the guide shafts 32. The biasing structure of the airbag system body and the arms in the restoring direction is not limited to the embodiment. For example, as shown in FIGS. 7(a) and 7(b), the arms 46B and 54B are biased in the restoring direction by a torsion spring 80 wound on the rotation axes 74 of the arms 46B and 54B.

The torsion spring 80 has a pair of coil portions (wound portions) 80a, a bridge portion 80b connecting the coil portions 80a, and stretched portions 80c stretched in the opposite directions from the respective coil portions 80a. The respective coil portions 80a are fitted to and retained by the rotation axes 74 of the respective arms 46B and 54B, and the respective stretched portions 80c abut against spring contacting pieces 82 provided in the respective arms 46B and 54B.

In the present embodiment, the arms 46B and 54B rotate (are restored) with the upward biasing force of the torsion spring 80 through the spring contact pieces 82. The other structures of the arms 46B and 54B are similar to those shown in FIG. 6, and the same reference numerals in FIGS. 7(a) and 7(b) denote the same elements.

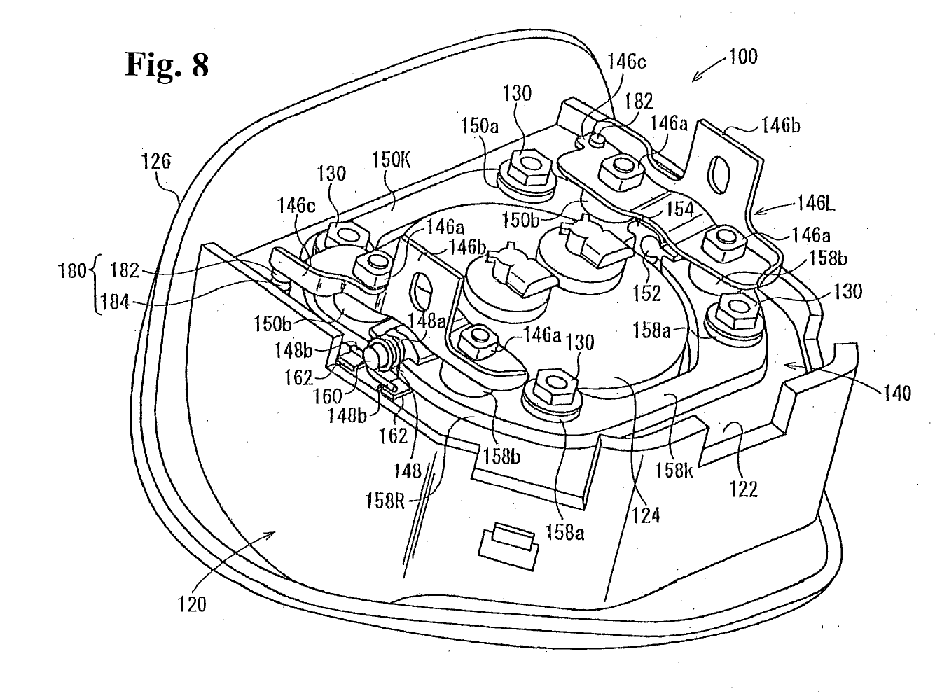

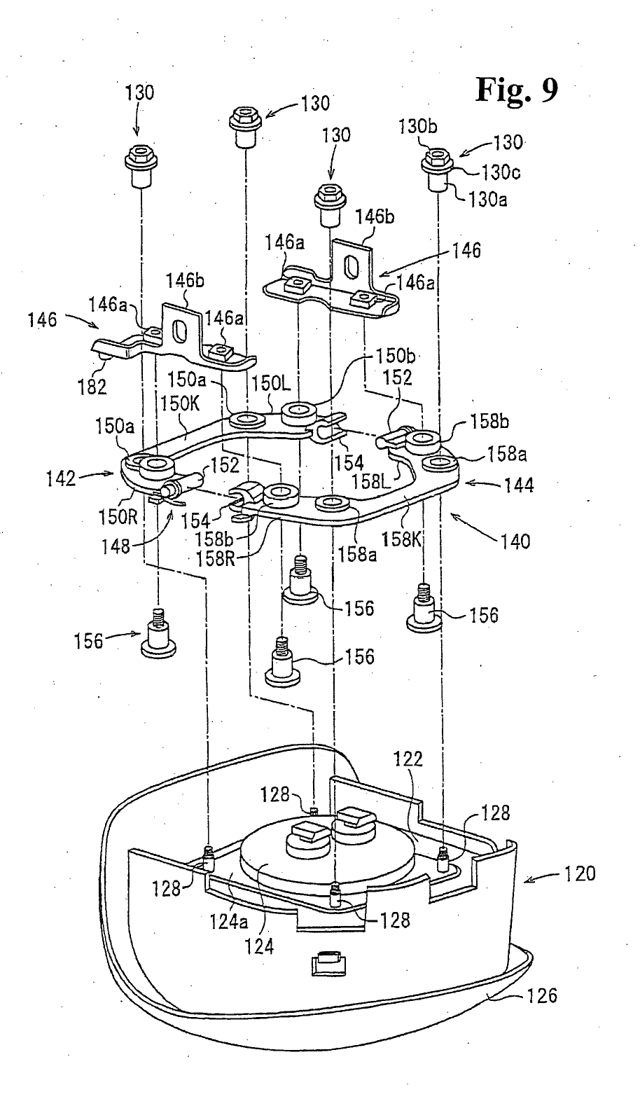

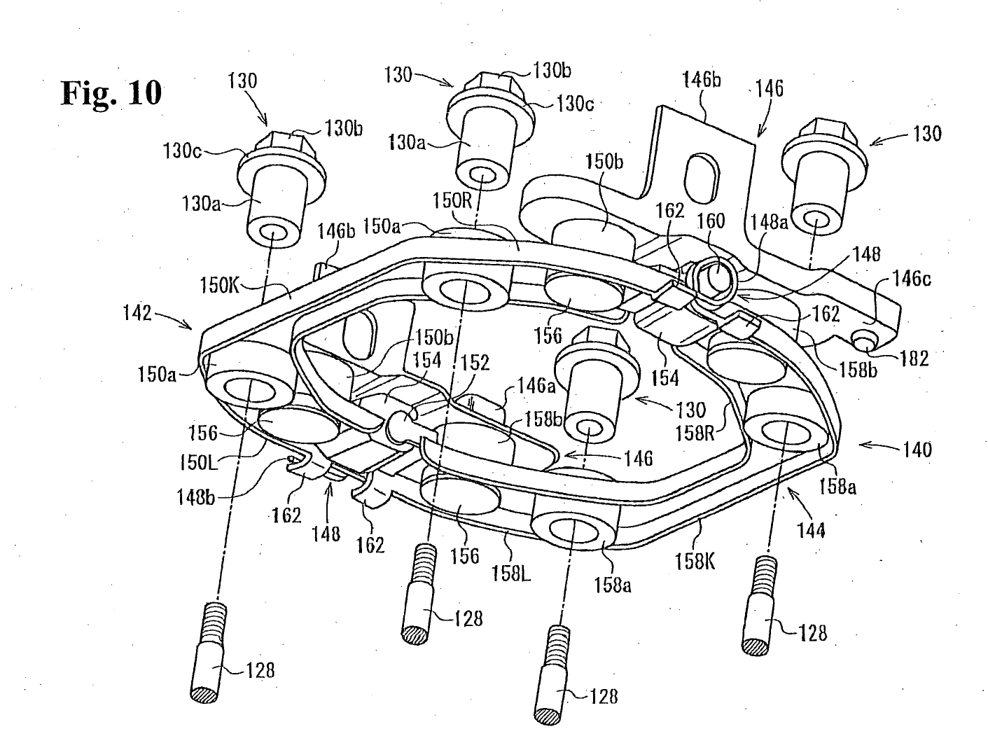

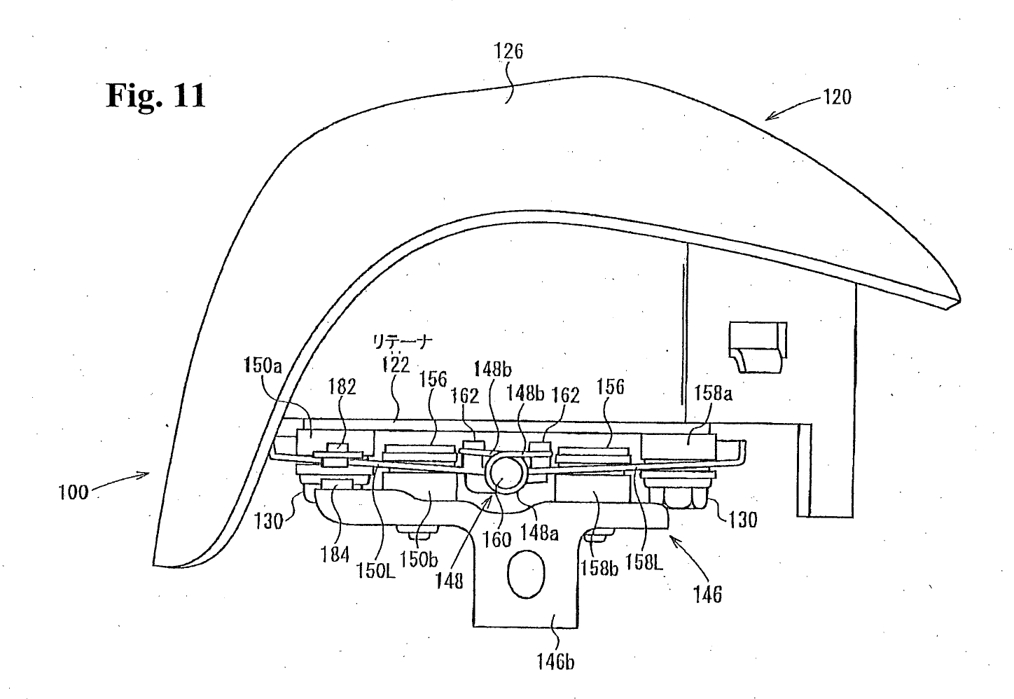

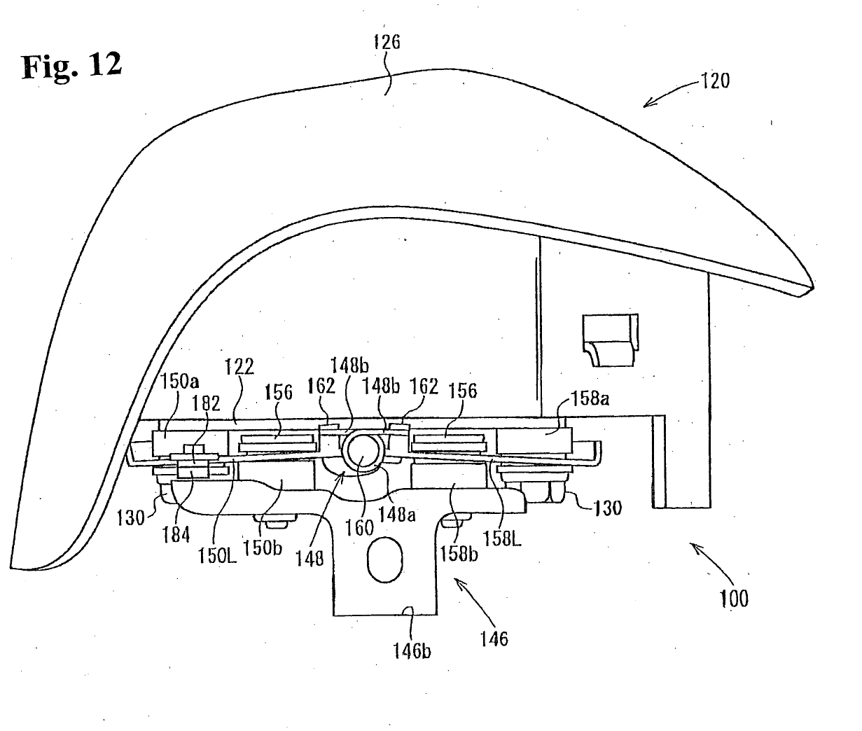

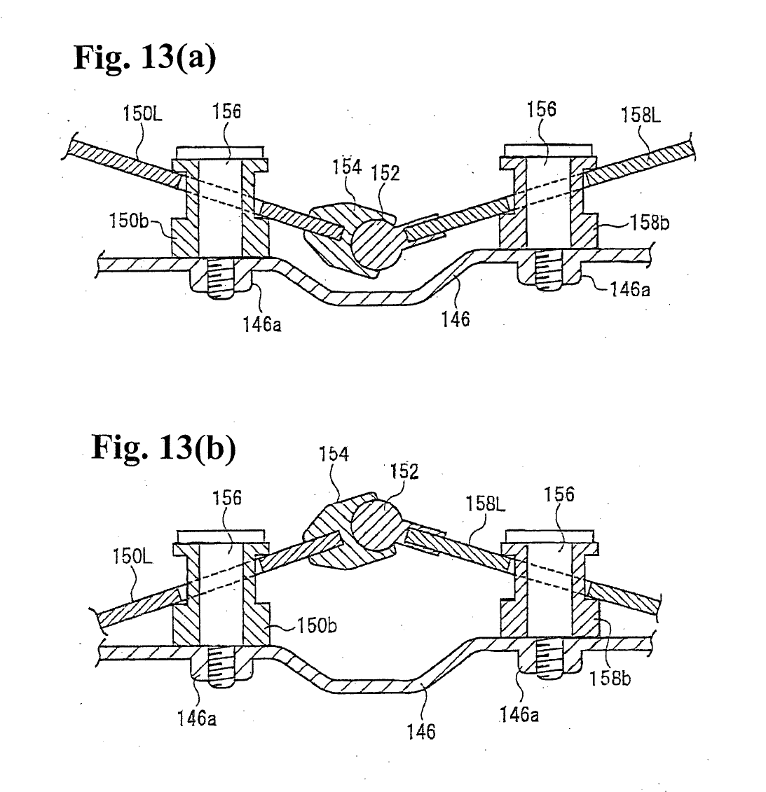

FIG. 8 is a perspective view of a rear surface (a guide frame side) of an airbag system 100 according to another embodiment of the present invention. FIG. 9 is an exploded perspective view of the airbag system 100, and FIG. 10 is a perspective view of the guide frame of the airbag system 100. FIGS. 11 and 12 are side views of the airbag system 100, and FIGS. 13(a) and 13(b) are cross-sectional views of a longitudinal portion of the arm schematically illustrating a mechanism of the guide frame of the airbag system 100. FIGS. 11 and 13(a) illustrate a state where a module cover is not pressed, and FIGS. 12 and 13(b) show a state where the module cover is pressed.

In the present embodiment, the airbag system 100 also comprises an airbag system body 120 disposed at the front surface (driver side) of the steering base (not shown); a guide frame 140 as a guiding device for guiding the airbag system body 120 such that the airbag system body is parallel-moved in an extension direction (a direction approaching and receding from the steering base) of the steering shaft (not shown); and a horn switch 180 to be turned on when the airbag system body 120 is guided along the guide frame 140 to move in parallel toward the steering base. The guide frame 140 is disposed at the rear surface (between the airbag system body 120 and the steering base) of the retainer 122 of the airbag system body 120.

Similarly to the airbag system body 20 shown in FIGS. 1 and 2, the airbag system body 120 also comprises a retainer 122; an airbag (not shown) fitted to the front surface of the retainer 122 with a fitting ring (not shown); a gas generator (inflator) 124 for inflating the airbag; and a module cover 126 fitted to the front surface of the retainer 122 to cover the airbag folded at the front surface of the retainer 122.

In the airbag system body 120, a gas-generator receiving port (not shown) at a base end of the airbag overlaps the retainer front surface at the circumferential edge portion of the gas-generator inserting port provided in a main panel portion (reference numeral omitted) of the retainer 122, and the fitting ring overlaps therewith.

The front end (gas discharging portion) of the gas generator 124 is inserted into the airbag through the gas-generator generator inserting port and the gas-generator receiving port. A flange 124s protruding from a side surface of the gas generator 124 overlaps the retainer rear surface at the circumferential edge portion of the gas-generator inserting port. Bolts 128 protruding from a rear surface of the fitting ring 24 are inserted into bolt inserting holes (not shown) provided at the circumferential edge portions of the gas-generator receiving port and the gas-generator inserting port and the flange 124. The bolts 128 protrude to the rear surface of the retainer 122. As shown in FIG. 9, the bolts 128 are disposed at the left and right sides (the left-and-right direction when the airbag system 100 is seen from the driver) of the upper portion of the retainer 122 and at the left side and right sides of the lower portion, respectively.

In the present embodiment, flange nuts 130 having collars are fastened to the bolts 128 through the guide frame 140, so that the airbag and the gas generator 124 are fixed to the retainer 122. Each flange nut 130 having the collar comprises a tubular collar portion 130a; a nut portion 130b provided at one end of the collar portion 130a in the axis direction; and a flange portion 130c formed between the collar portion 130a and the nut portion 130b and extending radially from the outer circumferential surface of the collar portion 130a. When the flange nut 130 having the collar is fastened to the bolt 128, the collar portion 130a is externally inserted into the base end of the bolt 128 and the nut portion 130b is fastened to the front end of the bolt 128.

The guide frame 140 comprises an upper frame 142 connected to the left and right bolts 128 on the retainer through the flange nuts 130 having the collars; a lower frame 144 connected to the left and right bolts 128 under the retainer through the flange nuts 130 having the collars; a pair of mount members 146L and 146R for connecting the upper frame 142 and the lower frame 144 to the steering base to rotate in the steering axis direction; and springs 148 as the urging device for biasing the upper frame 142 and the lower frame 144 in the direction in which the retainer 122 recedes from the steering base.

The upper frame 142 has a pair of arms 150L and 150R extending approximately in the up-and-down direction; a bridge portion 150K bridging the upper ends of the arms 150L and 150R; and male and female locking portions 152 and 154 provided at the lower ends of the arms 150L and 150R. The specific structure of the male locking portion 152 and the female locking portion 154 will be described later.

The upper end of each arm 150L or 150R is provided with an opening (not shown) for inserting the left and right bolts 128 (that is, the collar portions 130a externally inserted into the bolts 128) on the retainer, and the lower end (front end) thereof is provided with an opening (of which a reference numeral is omitted. See FIG. 11) for inserting a shoulder bolt 156 for connecting the respective arms 150L and 150R to the mount members 146L and 146L, respectively.

In the shoulder bolt 156, one end (front end) thereof is provided with a male screw portion (reference numeral omitted), and a portion extending from the male screw portion forms an axial portion (reference numeral) inserted into the opening. The other end (rear end) thereof is provided with a flange portion (reference numeral omitted) extending radially from the outer circumferential surface of the axial portion.

The opening at the upper end of each arm 150L or 150R is fitted with a bush 150a externally inserted into the collar portion 130a, and the opening at the lower end is fitted with a bush 150b externally inserted into the axial portion of the shoulder bolt 156. The bushes 150a and 150b may be made of rubber to permit the respective arms 150L and 150R to move (rotate) relative to the bolts 128 and the shoulder bolt 156, or may be fitted with a movable allowance relative to the openings.

The lower frame 144 has a pair of arms 158L and 158R extending approximately in the up-and-down direction, a bridge portion 158K bridging the upper ends of the arms 158L and 158R, and a male locking portion 152 and a female locking portion 154 provided at the upper ends of the arms 158L and 158R. The upper end of each arms 158L or 158R is provided with an opening (not shown) for inserting the left and right bolts 128 (the collar portions 130a under the retainer), and the upper end (front end) thereof is provided with an opening (reference numeral omitted; see FIG. 11) for inserting a shoulder bolt 156.

In the lower frame 144, the opening at the lower end of the each arm 158L or 158R is fitted with a bush 158a externally inserted into the collar portion 130a, and the opening at the upper end is fitted with a bush 158b externally inserted into the axial portion of the shoulder bolt 158. The bushes 158a and 158b may be made of rubber, or may be fitted with a movable allowance relative to the openings.

In the present embodiment, the male locking portion 152 has an approximately cylindrical shape, and the female locking portion 154 has an approximately C-shaped section to be slidably externally inserted into the outer circumference surface of the male locking portion 152, as shown in FIGS. 13(a) and 13(b). The male locking portion 152 and the female locking portion 154 are fixed to the front ends of the arms 150L, 150R, 158L, and 158R (hereinafter, referred to as the arms 150L to 158R).

In the present embodiment, the left arm 150L of the upper frame 142 and the right arm 158R of the lower frame 144 are provided with the male locking portion 152, and the right arm 150R of the upper frame 142 and the left arm 158L of the lower frame 144 are provided with the female locking portion 154. As shown in FIGS. 9 and 10, the upper frame 142 and the lower frame 144 are disposed such that the front ends of the left arms 150L and 158L face each other and the front ends of the right arms 150R and the 158R face each other. The male locking portion 152 and the female locking portion 154 of the left arms 150L and 158L are locked with each other, and the male locking portion 152 and the female locking portion 154 of the right arms 150R and 158R are locked with each other.

The mount members 146L and 146R are disposed at the left arms 150L and 158L locked with each other and at the right arms 150R and 158R locked with each other, respectively. A pair of nuts 146a and 146a is fixed to the mount members 146L and 146R, and the shoulder bolts 156 are inserted into the bushes 150b and 158b of the arms 150L to 158R, so that the respective arms 150L to 158R are connected to the mount members 146L and 146R, when the shoulder bolts 156 are screwed into the nuts 146a.

The bushes 150b and 158b are externally inserted into the axial portions of the shoulder bolts 156 and are retained between the flange portion at the rear end of the axial portion and the plate planes of the mount members 146L and 146R. The respective mount members 146L and 146R are provided with a bracket 146b for connecting the steering base and a contact retaining piece 146c attached to one contact 182 of the horn switch 180. The other contact 184 of the horn switch 180 is attached to a portion of the retainer 122 opposing the contact retaining piece 146c.

In the present embodiment, the spring 148 has a wound portion 148a with a coil shape and a pair of stretched portions 148b extending from the wound portion 148a in the directions that the stretched portions recede from each other. Spring retaining protrusions 160 are provided to the left and right male locking portions 152, respectively. The spring retaining protrusion 160 is an axial protrusion protruding coaxially with the male locking portion 152 from an end surface at one end of the male locking portion 152 in the axial direction (the opposite surface side of the opposing surfaces of the left and right arms; hereinafter, referred to as an outward surface side of an arm). The wound portion 148a of the spring 148 is fitted to the spring retaining protrusion 160. Stretched-portion locking pieces 162 protrude from the outward surfaces of the arms 150L to 158R, and the stretched portions 148b stretched from the wound portion 148a are locked to the stretched-portion locking pieces 162.

The guide frame 140 is connected to the airbag system body 120 by inserting the left and right bolts 128 on the retainer into the bushes 150a at the upper end of the arms 150L and 150R, inserting the left and right bolts 128 under the retainer into the bushes 158a at the lower end of the arms 158L and 158R, and fastening the flange nuts 130 having a collar to the bolts 128. When the flange nuts 130 having the collars are fastened to the bolts 128, the collar portions 130a are externally inserted into the bolts 128 while inserting the collar portions 130a into the bushes 150a and 158a, and the nut portions 130b are fitted to the front ends of the bolts 128. The bushes 150a and 158b externally inserted into the collar portions 130a are retained between the flange portions 130c at the rear end of the collar portion 130a and the plate surface of the retainer 122. The airbag system 100 having the aforementioned structure is fitted to the steering wheel when the brackets 146b of the respective mount members 146L and 146R are fixed to the steering base with bolts.

Next, an operation of the airbag system 100 will be described. In the airbag system 100, when the module cover 126 is pressed toward the steering wheel, as shown in FIGS. 12 and 13(b), the airbag system body 120 approaches the mount members 146 (steering base), and the contacts 182 and 184 of the horn switch 180 contact with each other to blow the horn.

At this time, the upper ends of the arms 150L and 150R of the upper frame 142 supporting the retainer 122 of the airbag system body 120 rotate toward the steering base about the bushes 150b. Also, the lower ends of the arms 158L and 158R of the lower frame 144 rotate toward the steering base about the bushes 158b. The lower ends of the arms 150L and 150R and the upper ends of the arms 158L and 158R are locked to each other through the male locking portions 152 and the female locking portions 154. Accordingly, the arms 150L and 150R and the arms 158L and 158R rotate while connecting with each other.

When a hand moves away from the module cover 126, the arms 150L to 158R rotate by means of the biasing force of the spring 148 such that the airbag system body 120 recedes from the steering base. Accordingly, the module cover 126 is restored to the state shown in FIGS. 11 and 13(a), and the contacts 182 and 184 are separated, thereby stopping the horn.

In the airbag system 100, the left arms 150L and 158L and the right arms 150R and 158R of the upper frame 142 and the lower frame 144 rotate while connecting with each other, respectively. Accordingly, the retainer 122 supported by the arms 150L to 158R is always parallel-moved toward the steering base, even when, for example, an outer edge portion of the module cover 126, not a center portion thereof, is pressed. As a result, even if any position of the module cover 126 is pressed, the reactive force applied to a finger tip of an operator (driver) is constant.

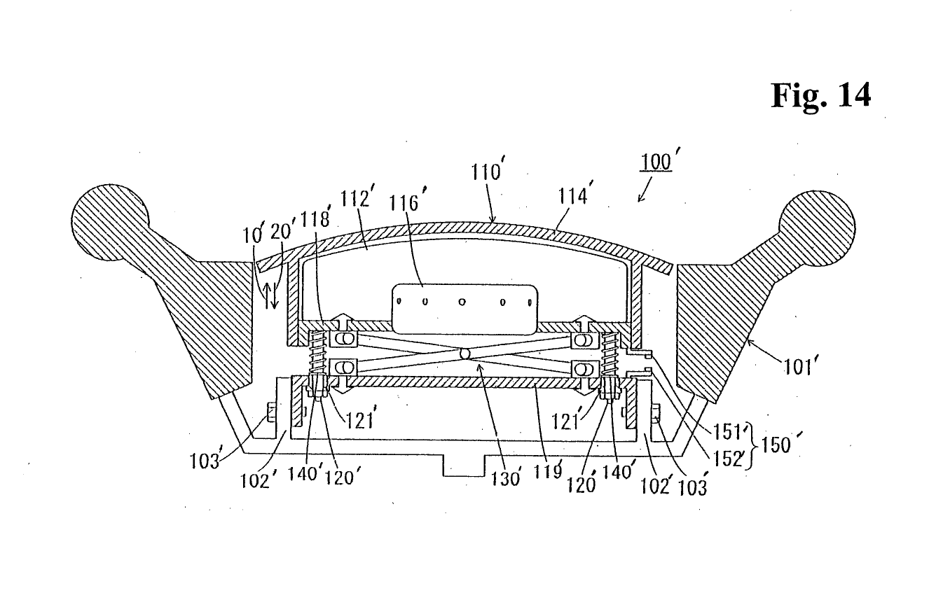

A further embodiment of the present invention will be described in detail with reference to the drawings. As shown in FIG. 14, a steering device 100′ comprises a steering wheel 101′ steering a vehicle; an airbag system 110′ fitted to the steering wheel 101′; a moving support plate 118′ and a stationary support plate 119′ facing each other; a link mechanism 130′ provided between the moving support plate 118′ and the stationery support plate 119′; and a horn switch device 150′. In the specification, the steering device 100′ may be referred to as an airbag system or a horn switch device.

The airbag system 110′ comprises an airbag 112′ disposed in the airbag system 110′ folded in a predetermined shape in advance; a module cover (airbag cover) 114′ for covering a driver side of the airbag 112′; and an inflator 116′ for supplying gas to the airbag 112′. When the inflator 116′ or a gas supply device supplies gas to the airbag 112′ in case of collision of a vehicle, the airbag 112′ is unfolded and expanded toward a driver protecting area while tearing the module cover 114′ along a tear line (not shown). The module cover 114′, i.e., a pressing portion or an airbag housing portion, houses the airbag 112′ and is pressed by a driver. The moving support plate 118′ is disposed adjacent to the airbag system 110′ for supporting a lower portion of the airbag system 110′. The moving support plate 118′ moves together with the airbag system 110′ when the module cover 114′ is pressed. The moving support plate 118′ is provided with guide bolts 120′ and a first switch contact 151′ of a horn switch device 150′ (described later).

The guide bolts 120′ have base ends protruding from the moving support plate 118′ and front ends extending toward the stationery support plate 119′, and coil springs 140′ or urging devices are disposed around the guide bolts 120′. The coil springs 140′ apply an elastic urging force to the moving support plate 118′ to move in a direction away from the stationery support plate 119′. In other words, the coil springs 140′ urge the module cover 114′ of the airbag system 110′ toward the initial position. The coil springs 140′ are disposed below a portion (the moving support plate 118′ in FIG. 14) moving integrally with the module cover 114′ as the pressing portion, or the urging device (coil springs 140′) is disposed below a pressing portion unit (the moving support plate 118′). The guide bolts 120′ have the front ends inserted into inserting holes of the stationery support plate 119′ in a state that the guide bolts are elastically urged by the coil springs 140′. An insulating member 121′ made of a resin is interposed between the guide bolts 120′ and the inserting holes of the stationery support plate 119′.

The stationery support plate 119′ is fixed to a bracket 102′ of the steering wheel 101′ with fixing bolts 103′, so that the airbag system 110′ is fitted to the steering wheel 101′. The airbag system 110′ is supported by the stationery support plate 119′ from below in a state where the airbag system is fitted to the steering wheel 101′. The stationery support plate 119′ is provided with a second switch contact 152′ of the horn switch device 150′ (described later) . The stationery support plate 119′ or a base portion is stationery relative to the airbag system 110′.

The horn switch device 150′ comprises the first switch contact 151′ provided in the moving support plate 118′ and the second switch contact 152′ provided in the stationery support plate 119′. The moving support plate 118 is moved toward the stationery supportplate 119′, so that the first switch contact 151′ or a moving contact electrically contacts the second switch contact 152′ or a stationery contact. Accordingly, the horn switch device 150′ is turned on and the horn blows. When the first switch contact 151′ is released from the second switch contact 152′, the horn switch device 150′ is turned off.

The link mechanism 130′ allows the moving support plate 118′ to move in a vertical direction indicated by an arrow 10′ or an arrow 20′ in FIG. 14, and regulates the moving support plate 118′ not to move in a direction other than the vertical direction. The arrow directions 10′ and 20′ extend between the initial position and the working position of the airbag system 110′, and correspond to the predetermined direction. The link mechanism 130′ defines the movement direction of the airbag system 110′ as a stabilizer, and corresponds to a movement-direction defining device. The link mechanism 130′ allows the airbag system 110′ to move in a direction slightly shifted from the arrow direction 10′ or 20′ for the sake of assembly, or regulates completely not to move in a direction other than the vertical direction.

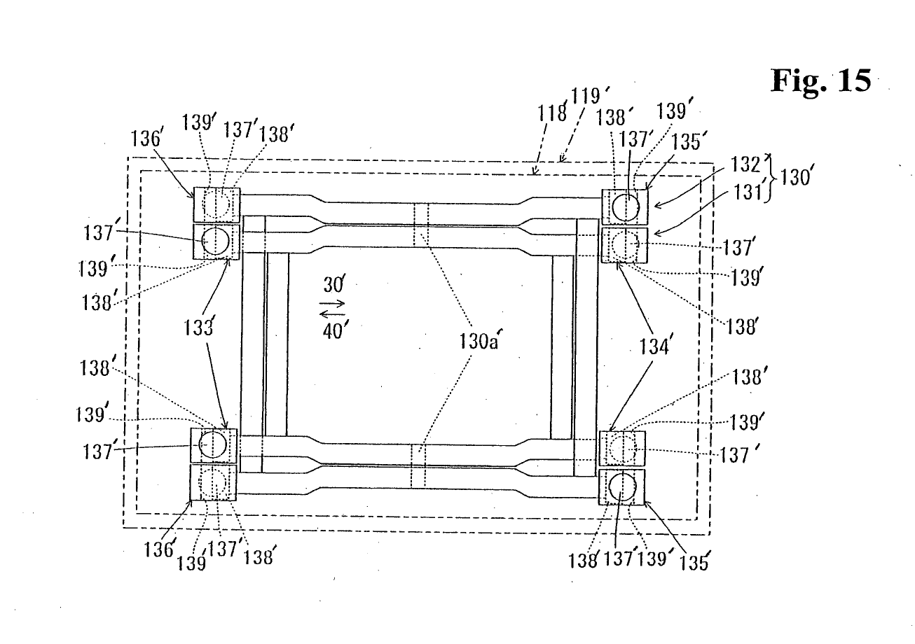

The link mechanism 130′ will be described in detail with reference to FIG. 15. FIG. 15 is a plan view of the link mechanism 130′ according to the present embodiment. As shown in FIG. 15, the link mechanism 130′ comprises two link frames 131′ and 132′ rotatable about rotating shafts 130a′. The link frames 131′ and 132′ are formed of longitudinal rectangular frames, and are connected to each other through the rotating shafts 130a′ to form an approximately X-shaped structure as seen from a side.

The first link frame 131′ includes two upper bearing portions 133′ at upper ends thereof and two lower bearing portions 134′ at lower ends thereof. In the present embodiment, the respective upper bearing portions 133′ and the respective lower bearing portions 134′ are made of resin and integrally provided with resin clips 137′. The respective upper bearing portions 133′ are attached to the moving support plate 118′ (the module cover 114′ or a moving unit) through the clips 137′, and the respective lower bearing portions 134′ are attached to the stationery support plate 119′ (base portion unit) through the clips 137′.

The second link frame 132′ includes two upper bearing portions 135′ at upper ends thereof and two lower bearing portions 136′ at lower ends thereof. In the present embodiment, the respective upper bearing portions 135′ and the respective lower bearing portions 136′ are made of a resin and integrally provided with the resin clips 137′. The respective upper bearing portions 135′ are attached to the moving support plate 118′ (the module cover 11440 or the moving unit) through the clips 137′, and the respective lower bearing portions 136′ are attached to the stationery support plate 119′ (the base portion unit) through the clips 137′.

Four ends of the link frames 131′ and 132′ are provided with slide shafts 138′, and long holes 139′ are formed in the respective bearing portions 133′, 134′, 135′, and 136′ for engaging the slide shafts 138′. The long holes 139′ extend linearly in a longitudinal direction perpendicular to the arrow directions 10′ and 20′ (the predetermined direction), that is, in the arrow directions 30′ and 40′ in FIG. 15 (the horizontal direction). The slide shafts 138′ or locking portions slide along the long holes 139′ in the horizontal direction.

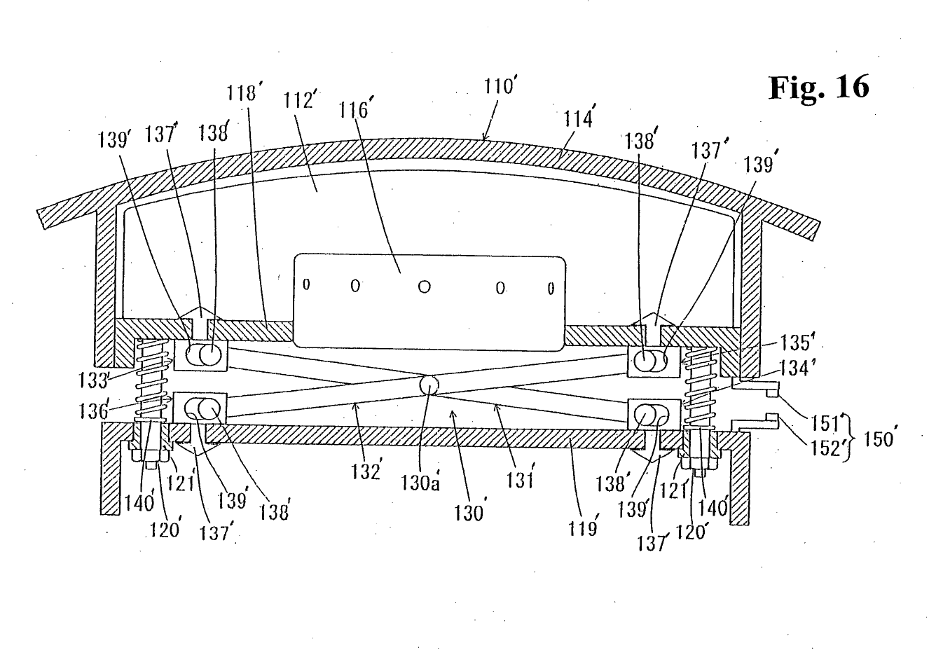

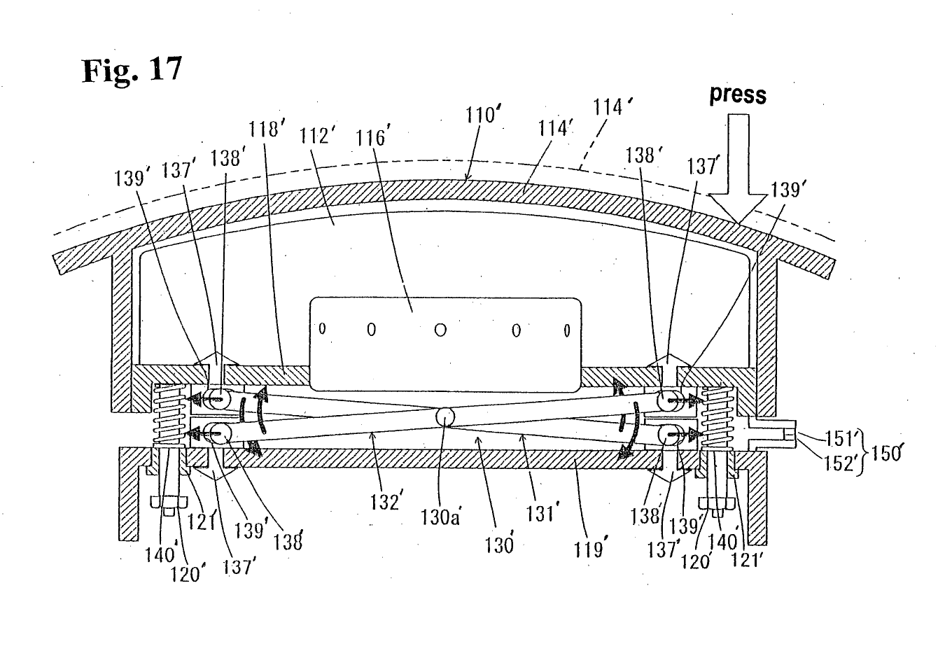

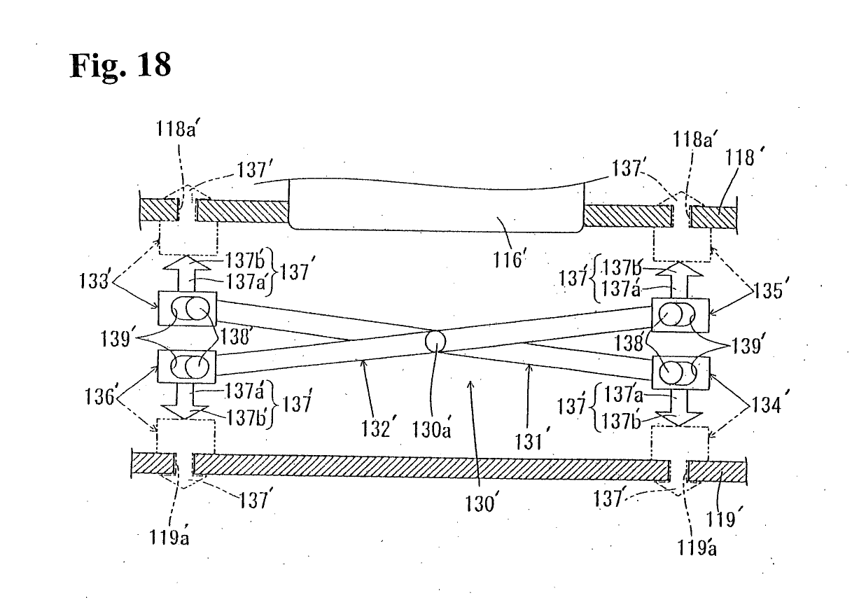

An operation of the airbag system 110′ and the link mechanism 130′ will be described with reference to FIGS. 16 and 17. FIG. 16 shows the airbag system 110′ and the link mechanism 130′ at the initial position, and FIG. 17 shows the airbag system 110′ and the link mechanism 130′ at the working position where the horn switch device 150′ is turned. The steering wheel 101′ is omitted in FIGS. 16 and 17.

Before a driver presses the module cover 114′ of the airbag system 110′, the airbag system 110′ and the link mechanism 130′ are situated at the initial position shown in FIG. 16. At the initial position, the slide shafts 138′ of the link frames 131′ and 132′ contact the long holes 139′ of the bearing portions 133′, 134′, 135′, and 136′, and the front ends (the lower side in FIG. 16) of the guide bolts 120′ penetrating the stationery support plate 119′ are locked to the stationery support plate 119′. Accordingly, the moving support plate 118′ does not move away from the stationery support plate 119′. At the initial position, the moving support plate 118′ and the stationery support plate 119′ are situated with a predetermined gap in between, and the coil springs 140′ elastically urge the moving support plate 118′ and the stationery support plate 119′ in the separating direction.

As shown in FIG. 17, when a driver presses the top surface of the module cover 114′ of the airbag system 110′ in the initial state to blow the horn, the whole airbag system 110′ moves from the initial position (indicated by a phantom line in the figure) to the working position (indicated by a solid line in the figure) to turn on the horn switch device 150′. At this time, the respective link frames 131′ and 132′ rotate about the rotating shafts 130a′ in a direction (an arrow direction in the figure) to approach each other, and the slide shafts 138′ of the link frames 131′ and 132′ slides outwardly in the long holes 139′, that is, in a direction (indicated by the arrow in the figure) away from the rotating shafts 130a′.

Accordingly, the moving support plate 118′ and the stationery support plate 119′ approach each other and the gap therebetween is narrowed. The link frames 131′ and 132′ and the slide shafts 138′ move about the rotating shafts 130a′ in the arrow directions shown in FIG. 17. When the first switch contact 151′ and the second switch contact 152′ contact with each other and are electrically connected to each other, the horn switch device 150′ is turned on, thereby blowing the horn. At this time, in the present embodiment, since the module cover 114′ is pressed and the movement direction of the airbag system 110′ is accurately defined by the link mechanism 130′, the airbag system 110′ is prevented from moving in a direction inclined about the arrow direction 20′ in FIG. 14 between the initial position and the working position.

When the driver releases the module cover 114′ of the airbag system 110′ in order to stop the horn, the airbag system 110′ moves to the initial position. At this time, the respective link frames 131′ and 132′ rotate about the rotating shafts 130a′ in the direction away from each other (opposite to the arrow directions in FIG. 17). The slide shafts 138′ of the link frames 131′ and 132′ slide inwardly in the long holes 139′, in the direction toward the rotating shafts 130a′ (opposite to the arrow directions in FIG. 17). Accordingly, the moving support plate 118′ moves away the stationery support plate 119′, thereby increasing the gap therebetween. When the driver releases the module cover 114′, the first switch contact 151′ is released from the second switch contact 152′, thereby turning off the horn switch device 150′ and stopping the horn.

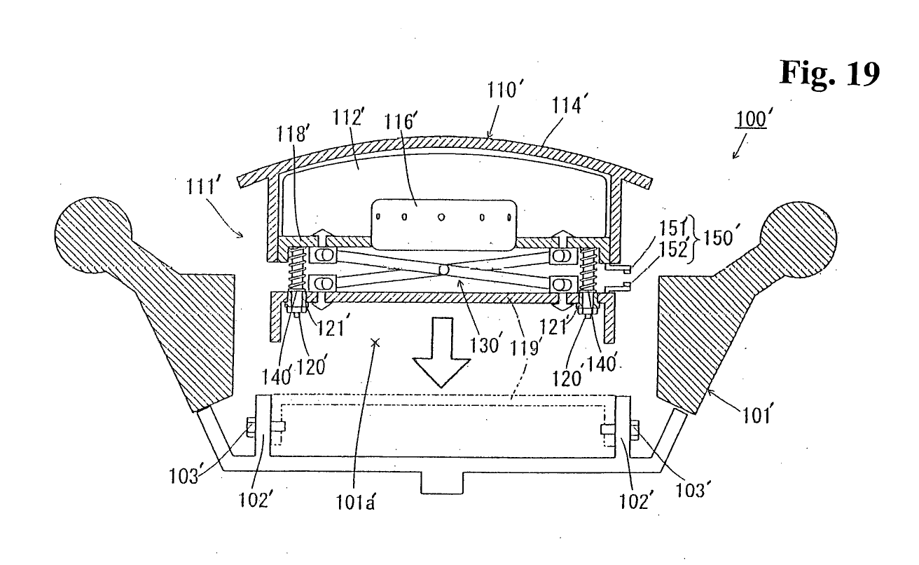

A process of assembling the main constituent elements to form the steering device 100′ having the aforementioned structure will be described next with reference to FIGS. 18 and 19. FIG. 18 shows a process of attaching the link mechanism 130′ to the moving support plate 118′ and the stationery support plate 119′ with the clips 137′. FIG. 19 show a process of attaching the airbag system 110′ to the steering wheel 101′ with the fixing bolts 103′.

In the present embodiment, when the steering device 100′ is assembled, in a step (Step A), the link mechanism 130′ is fitted between the moving support plate 118′ and the stationery support plate 119′. Specifically, as shown in FIG. 18, the clips 137′ provided in the upper bearing portion 133′ of the first link frame 131′ are fitted into the inserting hole 118a′ of the moving support plate 118′ from the front ends thereof (pressing), and the upper bearing portions 133′ are fixed to the moving support plate 118′ in a one-touch operation. The clips 137′ provided in the lower bearing portion 134′ of the first link frame 131′ are inserted into the inserting holes 119a′ of the stationery support plate 119′ from the front end thereof (pressing), and the lower bearing portions 134′ are fixed to the stationery support plate 119′ in a one-touch operation. The clips 137′ provided in the upper bearing portion 135′ of the second link frame 132′ are inserted into the inserting holes 118a′ of the moving support plate 118′ from the front end thereof (pressing), and the upper bearing portions 135′ are fixed to the moving support plate 118′ in a one-touch operation. The clips 137′ provided in the lower bearing portions 136′ of the second link frame 132′ are inserted into the inserting holes 119a′ of the stationery support plate 119′ from the front end thereof (pressing), and the lower bearing portion 136′ are fixed to the stationery support plate 119′ in a one-touch operation.

As shown in FIG. 18, the upper bearing portions 133′ and 135′ are fixed to the moving support plate 118′, and the lower bearing portions 134′ and 136′ are fixed to the stationery support plate 119′ in Step A as indicated by phantom lines. The resin clips 137′ have axial portions 137a′ having a shape corresponding to the inserting holes 118a′ and 119a′ and retaining portions 137b′ having a diameter larger than that of the axial portions 137a′ (that of the inserting holes 118a′ and 119a′). Accordingly, the respective bearing portions 133′, 134′, 135′, and 136′ are prevented from departing from the support plates 118′ and 119′ by the clips 137′. That is, the link mechanism 130′ can be easily and surely fixed (fitted) to the moving support plate 118′ and the stationery support plate 119′. As a result, the moving support plate 118′, the stationery support plate 119′, the link mechanism 130′, and the horn switch device 150′ are fitted to the airbag system 110′ to complete an single body assembly 111′.

In Step A, the link mechanism 130′ is fixed to the moving support plate 118′ and the stationery support plate 119′. It is possible to detach the link mechanism 130′ from the moving support plate 118′ and the stationery support plate 119′ by pushing out the respective clips 137′ from the inserting holes 118a′ and 119a′. The bearing portions 133′, 134′, 135′, and 136′, and the respective clips 137′ may be made of, for example, a hard rubber material or a metal material in addition to a resin. The respective clips 137′ may be integrally formed in the bearing portions 133′, 134′, 135′, and 136′, or may be formed individually and attached to the respective bearing portions 133′, 134′, 135′, and 136′ detachably or fixedly. The respective bearing portions 133′, 134′, 135′, and 136′ may be integrally formed in the respective link frames 131′ and 132′, or may be formed individually and attached to the respective link frames 131′ and 132′ detachably or fixedly.

When the steering device 100′ is assembled, the assembly 111′ is fixed to the steering wheel 101′ in a step (Step B) after Step A. Specifically, as shown in FIG. 19, the assembly 111′ is inserted into a recessed portion 101a′ formed almost at the central position of the steering wheel 101′. Then, the stationery support plate 119′ is fixed to the bracket 102′ of the steering wheel 101′. Therefore, the assembly 111′ is fixed to the steering wheel 101′, thereby completing the steering device 100′ of the present embodiment.

In this way, in the present embodiment, the assembly 111′ is prepared as a pre-assembled body (the ♭pre-assembled body” of the present invention) in which the assembly 111′ is fitted in advance, before being fitted to the steering wheel 101′. The link mechanism 130′ can be easily fixed to the moving support plate 118′ and the stationery support plate 119′ through the clips 137′ provided in the respective bearing portions 133′, 134′, 135′, and 136′ in a one-touch operation, thereby simply forming the assembly 111′ as the pre-assembled body. Accordingly, it is possible to easily fix the pre-assembled body (the assembly 111′) detachably to the steering wheel 101′ with the fixing bolts 103′.

As described above, according to the present embodiment, when the module cover 114′ is pressed to move the airbag system 110′, an inclined movement is prevented by the link mechanism 130′. Accordingly, when the driver presses the center or an end of the module cover 114′, the pressing force is uniformly applied to the module cover 114′. Therefore, regardless of a position of the module cover 114′ pressed by the driver, the pressing force for operating the horn can be constant, thereby obtaining the smooth operation.

According to the present embodiment, the movement-direction defining device or the link mechanism 130′ defines the movement direction of the airbag system 110′, and can be simply formed of the first link frame 131′, the second link frame 132′, and the rotating shaft 130a′. The link mechanism 130′ can be easily fitted to the moving support plate 118′ and the stationery support plate 119′ through the clips 137′. The airbag system 110′ smoothly moves toward the working position and the initial position in cooperation with the slide shafts 138′ and the long holes 139′ extending horizontally.

The coil springs 140′ are disposed below the moving support late 118′, so that the airbag 112′ can be folded or arranged above the moving support plate 118′, thereby arranging the airbag 112′ more freely. The airbag mechanism is formed of a simple structure and mounted in the steering device 100′. It is possible to fit (assemble) the link mechanism 130′ to the steering wheel 101′ with the clips 137′. It is also possible to fit and detach the assembly 111′ to and from the steering wheel 101′.

The present invention is not limited to the aforementioned embodiment, and various modifications are possible. For example, the aforementioned embodiment can be modified as follows.

In the aforementioned embodiment, the link mechanism 130′ comprises the two link frames 131′ and 132′ capable of rotating about the rotating shafts 130a′ for defining the movement direction of the airbag system 110′ upon pressing the module cover 114′. In the present invention, a stabilizer can be utilized for controlling the movement direction of the airbag system 110′. The number, shape, combination, etc. of the constituent elements (link frames 131′ and 132′, rotating shafts 130a′, bearing portions 133′, 134′, 135′, and 136′, clips 137′, etc.) of the link mechanism 130′ can be modified as needed.

In the above embodiment, the bearing portions 133′, 134′, 135′, and 136′ are provided at the both ends of the respective link frames 131′ and 132′ of the link mechanism 130′. The present invention may employ a structure different from the above structure. For example, the upper bearing portion 133′ and the lower bearing portion 136′ are omitted, and the first link frame 131′ may rotate only around the upper end thereof and the second link frame 132′ may rotate only around the lower end thereof. In this case, similarly to the link mechanism 130′ in the above embodiment, it is possible to smoothly move the airbag system 110′.

In the above embodiment, the long holes 139′ are formed in the link mechanism 130′ and linearly extend in the longitudinal direction for inserting the slide shafts 138′. The present invention may employ various shapes of the long holes 139′, as far as the desired cooperation with the slide shafts 138′ can be obtained. For example, the long holes may be formed in a curved shape or a stepped shape.

In the above embodiment, the assembly 111′ is formed of a single body in which the airbag system 110′, the moving support plate 118′, the stationery support plate 119′, and the link mechanism 130′ and the horn switch device 150′ are fitted to the steering wheel 101′, the present invention may employ various assembled structures as needed. For example, the moving support plate 118′, the stationery support plate 119′, and the link mechanism 130′ may be fitted (preassembled) to the steering wheel 101′ in advance, and then the airbag system 110′ is fitted to the assembled body.

In the aforementioned embodiment, the steering device of an automobile has the horn switch device. The present invention may be also applied to a vehicle other than an automobile having a horn switch device, such as a ship, an electric train, etc.

According to the aforementioned embodiments or various modifications, the present invention may employ structures according to Modifications 1 to 13 described below.

In Modification 1, an airbag system for a vehicle is fitted to a steering wheel of the vehicle, and includes at least an airbag to be unfolded and expanded in a driver protecting area in case of collision of the vehicle and a gas supply device for supplying to the airbag in an airbag housing portion. When the airbag housing portion is pressed to move the airbag housing portion to a working position, a horn blows. When the airbag housing portion is released to move the airbag housing portion to an initial position, the horn stops. The airbag system comprises a movement-direction defining device for defining the movement direction of the pressing portion. The movement-direction defining device allows the airbag housing portion to move in a predetermined direction passing through the initial position and the working position, and regulates the airbag housing portion not to move in a direction other than the predetermined direction.

In Modification 1, the airbag system has a structure almost the same as those of the steering devices in the twelfth aspect and the sixteenth aspect. Accordingly, the pressing force for blowing the horn to work can be constant regardless of a position of the airbag housing portion (pressing portion) pressed by a driver, so that it is possible to accomplish the smooth operation of the airbag system.

In Modification 2, in the airbag system according to Modification 1, the movement-direction defining device has a structure in which a plurality of long link frames is connected to a rotating shaft. One end of each link frame is fixed to the airbag housing portion, and the other end of each link frame is fixed to a base portion of the airbag system. The airbag housing portion and the base portion approach each other when the plurality of link frames rotates about the rotating shafts in an approaching direction in which the plurality of link frames approaches each other. The airbag housing portion and the base portion recede from each other when the plurality of link frames rotates about the rotating shafts in a separating direction in which the plurality of link frames recedes from each other.

In Modification 2, the airbag system has a structure almost the same as those of the steering devices according to the thirteenth aspect and the sixteenth aspect. Accordingly, the movement-direction defining device for defining the movement direction of the airbag housing portion (the pressing portion) can has a simple structure formed of the plurality of long link frames and the rotating shafts.

In Modification 3, in the airbag system according to Modification 2, the movement-direction defining device has a structure in which one end of each link frame is fixed to the airbag housing portion through clips in a one-touch way, and the other end of each link frame is fixed to the base portion through clips in a one-touch way. In Modification 3, the airbag system has a structure almost the same as those of the steering devices according to the fourteenth aspect and the sixteenth aspect. Accordingly, the movement-direction defining device comprising the plurality of long link frames and the rotating shafts can be easily fitted to the airbag housing portion (the pressing portion) and the base portion through the clips.

In Modification 4, in the airbag system according to Modification 2 or 3, the airbag housing portion or the base portion has long holes extending in a longitudinal direction. At least one end of each link frame comprises a locking portion movable along the long hole. The locking portions move along the long holes, when the plurality of link frames rotates in the approaching direction or the separating direction about the rotating shafts. In Modification 4, the airbag system has a structure almost the same as those of the steering device according to the fifteenth aspect and the sixteenth aspect. Accordingly, the airbag housing portion (the pressing portion) smoothly moves toward the working position and the initial position through cooperation between the locking portions and the long holes.

In Modification 5, in the airbag system according to any one of Modifications 1 to 4, the movement-direction defining device is provided as a pre-assembled body. Before the airbag system is mounted on the steering wheel of a vehicle, the movement-direction defining device is fitted in advance to the airbag housing portion. In Modification 5, the airbag system has a structure almost the same as those of the steering devices according to the sixteenth aspect and the seventeenth aspect. Accordingly, it is possible to enhance fitting ability (assembling ability) when the movement-direction defining device is fitted to the steering wheel of a vehicle.

In Modification 6, in the airbag system according to any one of Modifications 1 to 5, the urging device is disposed below the airbag housing portion for urging the airbag housing portion toward the initial position. In Modification 6, the airbag system has a structure almost the same as those of the steering devices according to the sixteenth aspect and the eighteenth aspect. Accordingly, the airbag can be folded or arranged in a wide area above the airbag housing portion (the pressing portion), thereby enhancing the degree of freedom in arrangement of the airbag.

In Modification 7, the horn switch device for a vehicle is fitted to the steering wheel of the vehicle. When the pressing portion is pressed to move to the working position, the blows. When the pressing portion is released to move to the initial position, horn stops. The steering device includes the movement-direction defining device for defining the movement direction of the pressing portion, i.e., allowing the pressing portion to move in a predetermined direction passing through the initial position and the working position and regulating the pressing portion not to move in a direction other than the predetermined direction.

In Modification 7, the horn switch device has a structure almost the same as that of the steering device according to the twelfth aspect. Accordingly, the pressing force for blowing the horn can be kept constant regardless of a position of the pressing portion pressed by a driver, so that it is possible to accomplish the smooth operation of the horn switch device.

In Modification 8, in the horn switch device according to Modification 7, the movement-direction defining device is formed of a plurality of the long link frames connected to the rotating shafts. One end of each link frame is fixed to the pressing portion, and the other end of each link frame is fixed to the base portion of the horn switch device. The pressing portion and the base portion approach each other by rotating the plurality of link frames about the rotating shafts in an approaching direction, while the pressing portion and the base portion recede from each other by rotating the plurality of link frames about the rotating shafts in a separating direction.

In Modification 8, the horn switch device has a structure almost the same as that of the steering device according to the thirteenth aspect. Accordingly, the movement-direction defining device for defining the movement direction of the pressing portion can be formed of a simple structure employing the plurality of long link frames and the rotating shafts.

In Modification 9, in the horn switch device according to Modification 8, the movement-direction defining device has a structure in which one end of each link frame is fixed to the pressing portion through the clip in a one-touch way, and the other end of each link frame is fixed to the base portion through the clip in a one-touch way.

In Modification 9, the horn switch device has a structure almost the same as that of the steering device according to the fourteenth aspect. Accordingly, the movement-direction defining device comprising the plurality of long link frames and the rotating shafts can be easily fitted to the pressing portion and the base portion through the clips.

In Modification 10, in the horn switch device according to Modification 8 or 9, the pressing portion or the base portion has the longitudinally-opened long holes and at least one end of each link frame comprises a locking portion movable along the long hole. The locking portions move along the long holes, when the plurality of link frames rotates in the approaching direction or the separating direction about the rotating shafts.

In Modification 10, the horn switch device has a structure almost the same as that of the steering device according to the fifteenth aspect. Accordingly, the movement of the pressing portion toward the working position and the initial position can be smoothly carried out through cooperation between the locking portions and the long holes.

In Modification 11, in the horn switch device according to any one of Modifications 7 to 10, the pressing portion is provided with at least the airbag to be unfolded and expanded in a driver-protecting area at the time of collision of a vehicle; the airbag cover for covering the driver side of the airbag; and the gas supply device for supplying gas to the airbag.

In Modification 11, the horn switch device has a structure almost the same as that of the steering device according to the sixteenth aspect. Accordingly, the reasonable structure in which the airbag mechanism is mounted on the pressing portion can be obtained.

In Modification 12, in the horn switch device according to any one of Modifications 7 to 11, the movement-direction defining device is provided as a pre-assembled body in which the movement-direction defining device is fitted in advance to the pressing portion, when the horn switch device is mounted on the steering wheel of a vehicle.

In Modification 12, the horn switch device has a structure almost the same as that of the steering device according to the seventeenth aspect. Accordingly, it is possible to enhance fitting ability when the movement-direction defining device is fitted to the steering wheel of a vehicle.

In Modification 13, in the horn switch device according to any one of Modifications 7 to 12, the urging device is disposed below the pressing portion for urging the pressing portion toward the initial position.

In Modification 13, the horn switch device has a structure almost the same as that of the steering device according to the eighteenth aspect. Accordingly, it is possible to enhance the degree of freedom in arrangement of elements disposed above the pressing portion. For example, in the structure having the airbag in Modification 11, the airbag can be folded or arranged in a wide area above the pressing portion, thereby enhancing the degree of freedom in arrangement of the airbag.

The disclosures of Japanese Patent Applications No. 2004-006599 filed on Jan. 14, 2004, No. 2004-007012 filed on Jan. 14, 2004 and No. 2004-323883 filed on Nov. 8, 2004 are incorporated in the application.

While the invention has been explained with reference to the specific embodiments of the invention, the explanation is illustrative and the invention is limited only by the appended claims.

1. A steering device comprising:
a cover device adapted to be disposed on a steering wheel,
a guiding device adapted to be disposed in the steering wheel for guiding the cover device to move parallel to an axial direction of the steering wheel, said guiding device including arms having first ends and second ends respectively, said first ends being joined together and supported such that the arms freely rotate together around the first ends in the axial direction, said second ends extending in directions away from each other and being connected to the cover device, and
a horn switch attached to the cover device for switching a horn when the cover device moves in the axial direction.

2. A steering device according to claim 1, wherein said second ends are connected to a bottom portion of the cover device.

3. A steering device according to claim 1, wherein said first ends engage each other.

4. A steering device according to claim 3, wherein each of said first ends includes a pinion for engaging each other.

5. A steering device according to claim 1, wherein one of said first ends includes a protruding portion protruding toward the other arm, and the other of said first ends includes a locking portion for engaging the protruding portion.

6. A steering device according to claim 5, wherein the locking portion is formed of a concave portion.

7. A steering device according to claim 1, further comprising an urging device attached to the cover device for urging the cover device so that the horn switch is turned off.

8. A steering device according to claim 1, further comprising an urging device attached to the arms for urging the arms so that the horn switch is turned off.

9. A steering device according to claim 1, further comprising an urging device attached to the first ends of the arms for connecting the first ends to move together and urging the arms so that the horn switch is turned off.

10. A steering device according to claim 9, wherein said urging device includes a wound portion and stretched portions extending from the wound portion in directions away from each other, said wound portion being attached to one of the arms, one of the stretched portions being fixed to the one of the arms and the other of the stretched portions being fixed to the other arm.

11. A steering device according to claim 10, wherein the one of the arms includes a spring retaining protrusion for holding the wound portion.

12. A steering device to be attached to a steering wheel of a vehicle, comprising:
a horn switch device adapted to be mounted on the steering wheel and having a base and a pressing portion moving to a working position from an initial position to turn on the horn switch device when the pressing portion is pressed, and
a movement-direction defining device attached to the pressing portion for defining the pressing portion to move along a predetermined direction between the initial position and the working position, said movement-direction defining device restricting the pressing portion from moving to directions other than the predetermined direction.

13. A steering device according to claim 12, wherein said movement-direction defining device includes a plurality of link frames and a rotating shaft connecting the link frames, each of said link frames having one end fixed to the pressing portion and the other end fixed to the base portion of the horn switch device, said link frames rotating about the rotating shaft in an approaching direction in which the link frames approach each other so that the pressing portion and the base portion approach each other, said link frames rotating about the rotating shaft in a separating direction in which the link frames separate from each other so that the pressing portion and the base portion separate from each other.

14. A steering device according to claim 13, further comprising a first clip for fixing the one end of the each of the link frames to the pressing portion and a second clip for fixing the other end of the each of the link frames to the base portion.

15. A steering device according to claim 13, wherein at least one of said pressing portion and said base-portion includes a long hole, and said one end of the each of the link frames includes a locking portion movable in the long hole when the link frames rotate about the rotating shaft, said locking portion being moved along the long hole when the plurality of the link frames rotates in the approaching direction or separating direction about the rotating shaft.

16. A steering device according to claim 12, wherein the movement-direction defining device is formed of a pre-assembled body fitted to the pressing portion before the steering device is mounted on the steering wheel.

17. A steering device according to claim 12, further comprising an urging device disposed under the pressing portion for urging the pressing portion toward the initial position.

18. An airbag system comprising the steering device according to claims 12, and an airbag to be inflated in case of an accident, an airbag cover for covering the airbag and a gas supply device attached to the airbag for supplying gas to the airbag, which are located in the pressing portion.

19. An airbag system comprising the steering device according to claim 1, and an airbag device mounted on the steering device, said cover device covering the airbag device and including a module cover.
